(19) United States
(12) Patent Application Publication
(10) Pub. No.: US 2012/0154469 A1
(43) Pub. Date: Jun. 21, 2012

(54) INKJET RECORDING APPARATUS AND INKJET RECORDING METHOD

(75) Inventors: Eiji Komamiya, Kawasaki-shi (JP); Yoshinori Nakajima, Yokohama-shi (JP); Mitsutoshi Nagamura, Tokyo (JP); Shingo Nishioka, Yokohama-shi (JP)

(73) Assignee: CANON KABUSHIKI KAISHA, Tokyo (JP)

(21) Appl. No.: 13/324,931

(22) Filed: Dec. 13, 2011

(30) Foreign Application Priority Data
Dec. 20, 2010 (JP) 2010-283775

(51) Int. Cl. B41J 29/38

(52) U.S. Cl. 347/14

(57) ABSTRACT

An inkjet recording apparatus recording image data by causing a recording head to scan in the going-and-returning directions of a certain direction includes a record unit that finishes recording with a first scan involving a discharge of ink and a second scan involving the ink discharge in the returning direction, to first and second regions in the going direction, and that varies the number of scanning which does not involve the ink discharge between the first and second regions, a generation unit generating record data specifying the ink discharge or the ink non-discharge for each pixel region of the first and second regions, and a determination unit determining the going-direction recording ratio and the returning-direction recording ratio in the pixel regions, wherein the generation unit generates the record data based on the determined going-direction recording ratio and returning-direction recording ratio.

### BACKGROUND OF THE INVENTION

1. Field of the Invention

The present invention relates to an inkjet recording apparatus and an inkjet recording method that are provided to record image data by discharging a record liquid such as an ink onto a recording medium while causing a recording head to perform scanning.

2. Description of the Related Art

Serial-type inkjet recording apparatuses provided with a carriage including a recording head having a plurality of nozzles discharging inks and an ink tank, a conveying unit which conveys a recording medium, and a control unit controlling the above-described components are widely used. The inkjet recording apparatus repeatedly performs main scanning and sub scanning. In the main scanning, the carriage is moved in a direction intersecting the direction in which the recording medium is conveyed (main-scanning direction) and the recording head discharges ink to record data. In the sub scanning, the recording medium is conveyed by as much as the distance corresponding to the record width of the recording head at the recording operation. Many of the currently-used inkjet recording apparatuses are configured to record a full-color image by using inks of multiple colors. For example, a recording head that can discharge inks of yellow (Y), magenta (M), cyan (C), black (Bk), etc. is mounted on the carriage, and a full-color image is recorded using the above-described inks. The carriage often includes two or more recording heads provided for the inks, where the recording heads are sequentially arranged in the main-scanning direction.

When the recording heads are arranged in order of Bk, C, M, and Y in the forward direction of the main scanning, data is recorded onto a recording medium in order of Bk, C, M, and Y with forward-direction scanning, and in order of Y, M, C, and Bk with backward-direction scanning. Thus, the recording order in the backward-direction scanning is opposite from the recording order in the forward-direction scanning and therefore the order in which the inks are superimposed on one another on the recording medium in the backward-direction recording differs from the order in the forward-direction recording. Accordingly, the hue may vary corresponding to the conveyance distance of the recording-medium, causing an uneven color image. As a consequence, the image quality may be decreased.

The technology for reducing the above-described unevenness due to the difference in recording-order in the two-way recording performed to record data in the forward direction and the backward direction is disclosed in U.S. Pat. No. 5,500,661. More specifically, U.S. Pat. No. 5,500,661 discloses a method in which order of recording onto a record region by inks is constant at all times by conveying a sheet in the normal direction and the backward direction alternately when a recording operation is performed in the forward direction and the backward direction based on record data. Thus, it becomes possible to reduce unevenness in color occurring in a record region, the unevenness in color being caused by the difference in recording order, by causing the order in which the inks are superimposed on one another on a recording medium to be constant.

However, according to the technology disclosed in U.S. Pat. No. 5,500,661, the time difference (interval) between the preceding recording scan (also referred to as preceding dotting) and the following recording scan (also referred to as following dotting) varies among regions. For example, as illustrated in FIG. 4 of U.S. Pat. No. 5,500,661, the preceding-dotting recording is performed for a first scan and the following-dotting recording is performed for a second scan in a first region and a second region except the lower-most raster. On the other hand, the preceding-dotting recording is performed for a first scan and the following-dotting recording is performed for a fourth scan for the lower-most raster of the second region, so that the time difference (interval) between the preceding-dotting recording and the following-dotting recording varies among the regions. As a consequence, unevenness due to the time-difference caused by differences in penetration, fusing, and drying of the inks in the recording medium occurs.

### SUMMARY OF THE INVENTION

Accordingly, the present invention describes an inkjet recording apparatus and an inkjet recording method that can reduce the occurrence of the time difference unevenness caused by the difference in time intervals between the preceding-dotting recording scan and the following-dotting recording scan depending on recording regions.

In one aspect, the present invention discloses an inkjet recording apparatus recording an image onto a recording medium by causing a recording head including nozzle arrays of multiple colors, the nozzle arrays being arranged in a certain direction, to scan in a going direction and a returning direction of the certain direction, the inkjet recording apparatus including a record unit configured to finish recording with a first scan performed in the going direction, the first scan involving a discharge of ink to first and second regions of a recording medium, and a second scan performed in the returning direction, the second scan involving a discharge of ink to the first and second regions of a recording medium, and vary the number of scanning which does not involve a discharge of ink between the first and second regions, the scanning being performed between the first and second scans, a generation unit configured to generate record data specifying a discharge of ink or a non-discharge of ink based on input image data for each pixel region of the first region and the second region, and a determination unit configured to determine a ratio of recording performed in the going direction and a ratio of recording performed in the returning direction based on a value of the input image data in a plurality of the pixel regions, wherein the generation unit generates the record data based on the going-direction recording ratio and the returning-direction recording ratio that are determined by the determination unit.

Embodiments of the present invention describe that the occurrence of the time-difference unevenness can be reduced, the time-difference unevenness being caused by the difference in time intervals between the preceding-dotting recording scan and the following-dotting recording scan depending on recording regions.

Further features of the present invention will become apparent from the following description of exemplary embodiments with reference to the attached drawings.

### BRIEF DESCRIPTION OF THE DRAWINGS

FIG. 1 is a plan view of an inkjet recording apparatus according to a first embodiment of the present invention.

FIG. 2 is a plan view which schematically illustrates the arrangement of discharge ports of a recording head according to the first embodiment.

FIG. 3 is a block diagram illustrating the schematic configuration of a control system according to the first embodiment.

FIGS. 4A to 4C are diagrams which schematically illustrate processing procedures performed to generate record data according to the first embodiment.

FIG. 5 schematically illustrates an exemplary 2-column thinning method performed in the first embodiment.

FIG. 6 schematically illustrates processing procedures performed to generate record data according to the first embodiment.

FIGS. 7A and 7B are diagrams which schematically illustrate dot-arrangement pattern data used in the first embodiment.

FIGS. 8A to 8C are tables which schematically illustrate index-pattern switching procedures performed for a recording-direction ratio change determination method 1 according to the first embodiment.

FIGS. 9A to 9C are tables which schematically illustrate index-pattern selection processing procedures performed in the first embodiment.

FIG. 10 is a flowchart relating to the processing procedures performed to generate the record data according to the first embodiment.

FIGS. 11A to 11F are tables which schematically illustrate data-processing results obtained to form an image in a certain region according to the first embodiment.

FIGS. 12A to 12D are diagrams illustrating recording operations performed in the first embodiment.

FIGS. 13A and 13B illustrate a time-difference unevenness occurrence mechanism.

FIGS. 14A and 14B illustrate a time-difference unevenness reduction mechanism.

FIG. 15 illustrates a record-data processing method according to a second embodiment of the present invention.

FIGS. 16A to 16D illustrate elapsed times consumed until data is recorded onto each region according to a recording method of the second embodiment.

FIGS. 17A to 17C illustrate main-scanning time-difference tables according to the second embodiment.

FIG. 18 is a flowchart relating to processing procedures performed to generate record data according to the second embodiment.

FIGS. 19A to 19F are tables which schematically illustrate data-processing results obtained to form an image in a certain region according to the second embodiment.

FIGS. 20A to 20C are tables which schematically illustrate index-pattern switching procedures performed for a recording-direction ratio change determination method 2 according to a third embodiment of the present invention.

FIG. 21 is a table which schematically illustrates an exemplary 2-column thinning method performed according to a fourth embodiment of the present invention.

FIGS. 22A and 22B schematically illustrate dot-arrangement pattern data used for the fourth embodiment.

### DESCRIPTION OF THE EMBODIMENTS

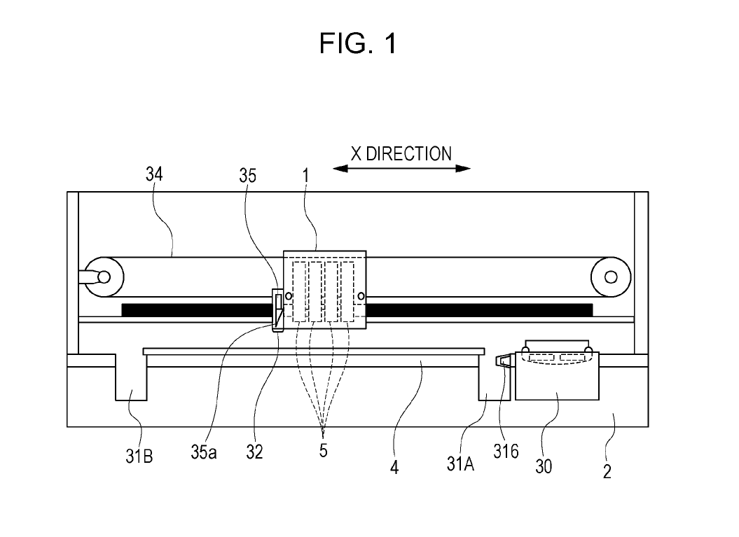

Hereinafter, embodiments of the present invention will be described in detail with reference to the attached drawings. FIG. 1 is a plan view of an inkjet recording apparatus (hereinafter often referred to as the recording apparatus) according to an embodiment of the present invention. The inkjet recording apparatus illustrated in FIG. 1 is configured to record data onto a relatively large recording medium and provided with a main body 2 including a conveying unit (not shown) configured to convey the recording medium in the conveyance direction. A carriage 1 is attached to the main body 2 in such a manner that the carriage 1 can move along a guide shaft (not shown) in the main-scanning direction.

The carriage 1 can reciprocate along the main-scanning direction (X direction) of a certain direction, which intersects the conveyance direction by driving power transferred from a carriage motor (not shown) via a belt 34. A plurality of recording heads 5, each of which including a plurality of nozzles configured to discharge ink droplets, is incorporated into the carriage 1, and the recording heads 5 travel in the main-scanning direction along with the carriage 1. The carriage 1 is further provided with an optical sensor 32. The optical sensor 32 detects whether or not the recording medium is placed on a platen 4 while travelling in the main-scanning direction along with the carriage 1. Further, the inkjet recording apparatus of the present embodiment is provided with a non-discharging nozzle-detection unit (not shown) including a light-projection part and a photo-detection part that can detect the non-discharge of ink for each of the nozzles of the recording heads 5. More specifically, the light-projection part and the photo-detection part detect the non-discharge of ink for each of the nozzles by detecting the presence or absence of ink droplets interrupting an optical path extending from the light-projection part to the photo-detection part.

Further, the inkjet recording apparatus 2 includes a recording-head recovery unit to maintain the discharge capability of each of the nozzles of the recording heads 5 in an appropriate state. The recording-head recovery unit includes a suction-recovery mechanism 30 including caps that are attached to a pump. Discharge ports that are provided on the ends of the nozzles of the recording heads 5 are covered with the caps, and thickened ink or the like remaining in the nozzles is sucked and discharged by negative pressure caused in the caps by the pump.

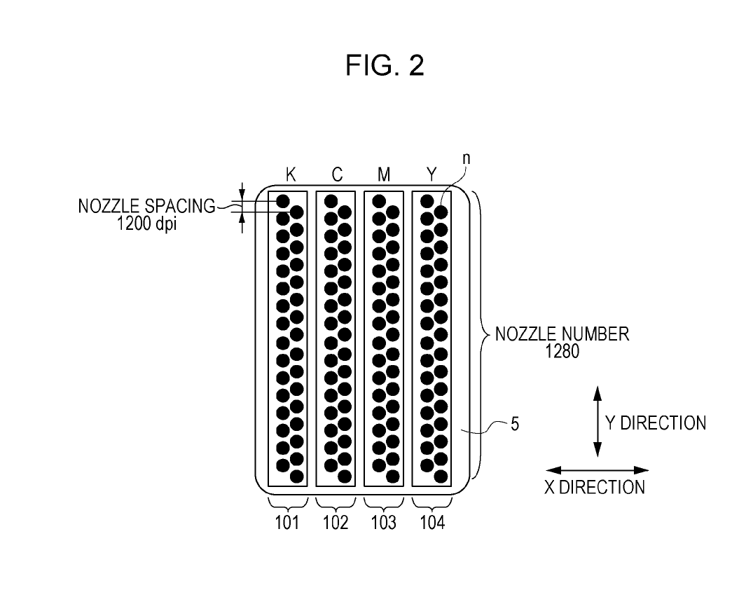

FIG. 2 is a plan view which schematically illustrates an arrangement of the discharge ports of a recording head according to an embodiment of the present invention, that is, the recording head 5 including a plurality of nozzles configured to discharge ink. Each of the nozzles includes a discharge port n from which ink is discharged and an ink channel (not shown) communicated with the discharge port n. An electric thermal conversion member is provided in the ink channel of each of the nozzles. The electric thermal conversion member is configured to cause film boiling by locally heating the ink so that the ink is discharged by the bubble generating energy of the film boiling.

The discharge port arrays corresponding to inks of multiple colors are provided on the recording head 5. Each of the discharge port arrays of the present embodiment includes 1280 discharge ports arrayed at a density of 1200 dpi along the sub-scanning direction which is the direction in which the recording medium is conveyed. For achieving the above-described configuration, two sub-discharge port arrays (including an ODD array and an EVEN array), each of which including 640 discharge ports arrayed at a density of 600 dpi in the conveyance direction (Y direction), are provided for each ink color in the present embodiment.

In the present embodiment, the recording head 5 is provided as a transverse-array head including discharge-port (nozzle) arrays 101, 102, 103, and 104 discharging inks of black (Bk), cyan (C), magenta (M), and yellow (Y) to record full-color image data. The nozzle array 101 discharging the ink of Bk, the nozzle array 102 discharging the ink of C, the nozzle array 103 discharging the ink of M, and the nozzle array 104 discharging the ink of Y are sequentially provided along the X direction.

In the above-described inkjet recording apparatus, the recording medium is conveyed from a conveying unit (not shown) toward the sub-scanning direction. The recording head 5 receives a record signal transmitted from a record-and-control unit (not shown), and discharges the ink toward a recording area of the recording medium while traveling toward the main-scanning direction along with the carriage 1. The above-described recording operation and a conveying operation performed to convey the recording medium toward the sub-scanning direction by as much as a certain amount are repeated for recording.

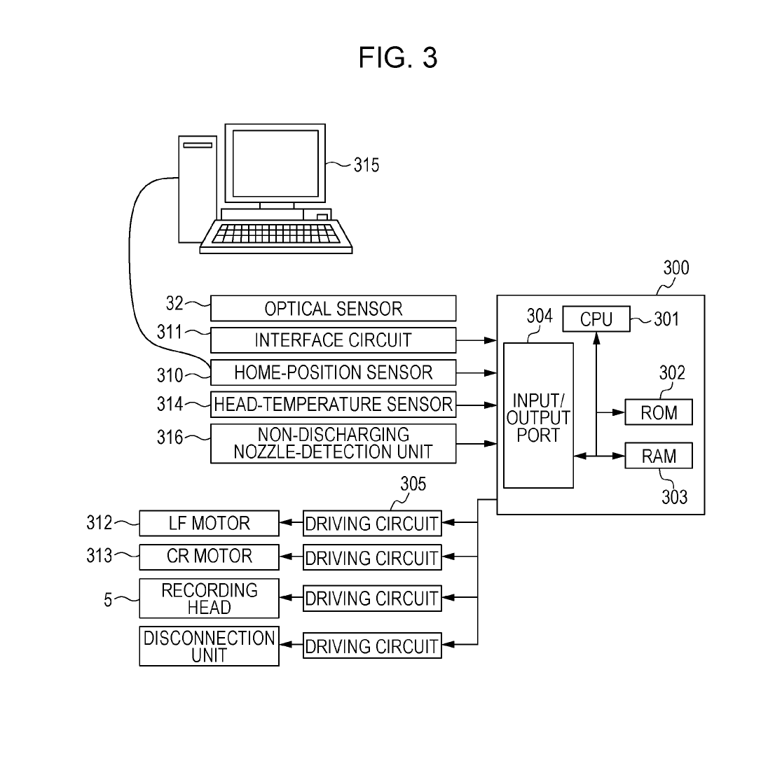

FIG. 3 is a block diagram which schematically illustrates the configuration of a control system of the present embodiment. A main control unit 300 has a CPU 301 executing processing operations including a computation, a selection, a distinction, a control, and so forth, a ROM 302 storing a control program or the like that should be executed with the CPU 301, a RAM 303 used as, for example, a buffer of record data, an input-and-output port 304, etc. Here, the CPU 301 functions as a first selection unit performing a selection procedure which will be described later and a second selection unit.

A convey motor (line feed (LF) motor) 312, a carriage (CR) motor 313, the recording head 5, and driving circuits 305, 306, 307, and 308 including, for example, an actuator provided in a disconnection unit are connected to the input-and-output port 304. Further, various types of sensors are connected to the input-and-output port 304. For example, a head temperature sensor 314 detecting the recording-head temperature, a home position sensor 310 detecting that a carriage 1 stays at the home position where a recovery operation is performed, and a non-discharging nozzle-detection unit 316 inspecting the discharging state of the recording head 5, etc. are connected to the input-and-output port 304. Further, the main control unit 300 is connected to a host computer 315 via an interface circuit 311. Recording operations performed with the above-described inkjet recording apparatus will be described.

### First Embodiment

According to a first embodiment of the present invention, multi-valued input image data is converted into binary data (record data) indicating whether or not dots should be formed, that is, whether or not ink droplets should be discharged from the recording head 5 based on dot-arrangement pattern data (also referred to as index-pattern data) which will be described later. The above-described binarization is achieved with a host apparatus quantizing image data into data of a relatively low resolution and transferring the quantized multi-valued image data to the main body of the recording apparatus. In the main body of the recording apparatus, the transferred image data is converted into binary data (record data) based on the index-pattern data, and expanded into a buffer.

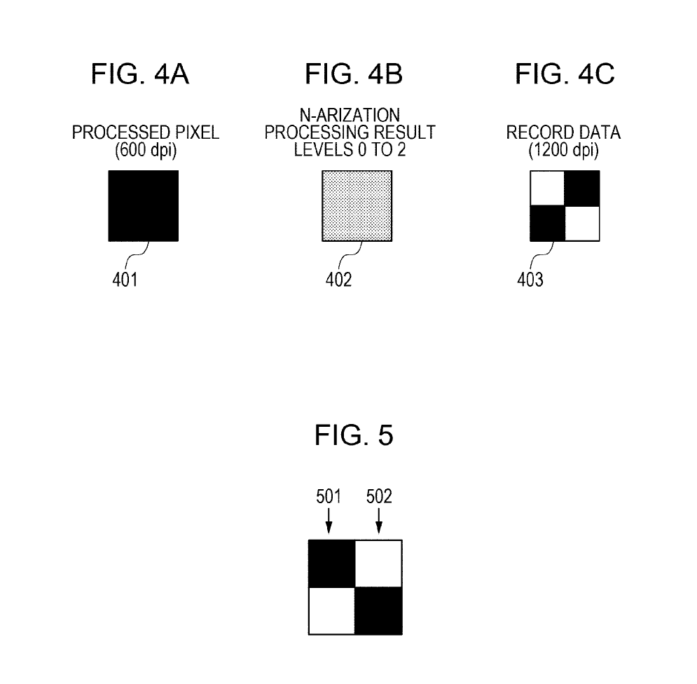

FIGS. 4A, 4B, and 4C schematically illustrate processing procedures that are performed in the main body of the recording apparatus from when the multi-valued input data is transferred to when the record data is generated. In FIG. 4A, the input image data transmitted from the host computer 315 is converted into internally processed pixel data 401 of a resolution of 600 dpi. Here, the term “pixel data” denotes multi-valued image data provided to give the ink to a single pixel which is the minimum region unit of the input image data. At that stage, the pixel data has levels 0 to 255.

Next, the pixel data 401 is quantized to input data having three levels 0 to 2, and quantization-processing result data 402 is obtained as illustrated in FIG. 4B. Then, binary record data 403 indicating whether or not dots should be formed is allocated to a matrix M (unit region) including two vertical areas by two horizontal areas, which is illustrated in FIG. 4C, based on index-pattern data specified in advance. Here, the record data indicates the dot formation, and is used as a data signal used to discharge ink droplets. Processing is performed based on the index-pattern data (hereinafter referred to as the index processing) to generate record data of a resolution of 1200 by 1200 dpi. As above, the record-data generation processing has been briefly explained.

When the above-described record data is transmitted to the main control unit 300, the CPU 301 controls the driving of the motors, the recording heads, etc. via the input-and-output port 304 based on programs that are installed in the ROM 302, data stored in the RAM 303, and so forth to perform a recording operation. The recording operation is performed according to, for example, the following recording method. Namely, a single record scanning operation performed with the recording head to record image data allocated in a region is divided into a plurality of record scanning operations to increase the driving speed of the carriage 1. The above-described recording method is referred to as a division recording method. A recording technology described in the first embodiment is achieved by performing the division recording method and the above-described record-data generating method. Hereinafter, the recording technology of the first embodiment will be specifically described.

The division recording method of the first embodiment is achieved according to a two-column thinning method that allows for decreasing the record resolution attained by each record scanning operation and recording specified column data only for each record scanning operation.

FIG. 5 schematically illustrates an exemplary two-column thinning method performed according to the first embodiment. According to the exemplary two-column thinning method, record data is divided into odd-column data and even-column data, and a record-scanning operation performed based on the odd-column data and that performed based on the even-column data are repeated by turns. Therefore, column data that should be used for each record-scanning operation is uniquely determined.

When data recording is performed based on column data 501 and column data 502 that are sequentially allocated from the left end of the drawing toward the right direction for the record data of a matrix (unit region) including two vertical areas by two horizontal areas, which is illustrated in FIG. 5, each column data is recorded as below. When a two-way record-scanning operation is performed according to the two-column thinning method, the odd-column data 501 is used to perform a record-scanning operation toward a forward direction (hereinafter referred to as the forward scanning) and the even-column data 502 is used to perform a record-scanning operation toward a backward direction (hereinafter referred to as the backward scanning).

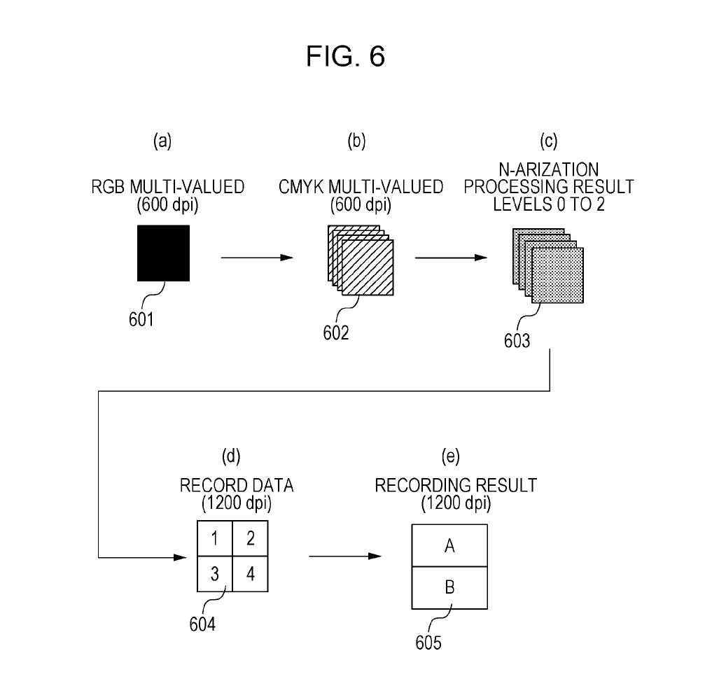

FIG. 6 schematically illustrates procedures performed to generate record data according to the first embodiment. Input RGB multi-valued pixel data is processed into pixel data 601 of a resolution of 600 dpi as illustrated in part (a) of FIG. 6. Next, input RGB multi-valued (8 bits: 0 to 255) pixel data is converted into CMYBk multi-valued (8 bits: 0 to 255) pixel data 602 as illustrated in part (b) of FIG. 6. Then, the CMYBk multi-valued pixel data is converted into three-level (0 to 2) CMYBk pixel data as illustrated in part (c) of FIG. 6 through the quantization processing. Next, record data that should be allocated into the matrix M including two horizontal areas by two vertical areas, which are illustrated in part (d) of FIG. 6, are generated with reference to index-pattern data which will be described later based on the level of each quantized pixel data.

Considering the above-described two-column thinning method and the positions of areas of the matrix M, into which record data are allocated, record data that are expanded in areas illustrated with numerals 1 and 3 that are written in the matrix M, are used to perform the forward-direction record-scanning operation. On the other hand, record data that are expanded in areas illustrated with numerals 2 and 4 that are written in the matrix M, are used to perform the backward-direction record-scanning operation.

The positions where dots land when actual data recording is performed based on the above-described binary record data are shown as recording-result data 605 illustrated in part (e) of FIG. 6. Since the recording resolution is determined to be 600 dpi, an ink droplet discharged based on the binary record data that are expanded in the areas 1 and 2 of the matrix M lands at a landing position A. Likewise, an ink droplet discharged based on the record data that are expanded in the areas 3 and 4 lands at a landing position B.

When image data is recorded at a horizontal record resolution of 600 dpi based on record data of a horizontal resolution of 1200 dpi, pixel data allocated to the areas 1 and 3 are used to perform the forward-direction record-scanning operation in consideration of the property of the two-column thinning method and the landing positions of the ink droplets. On the other hand, the pixel data allocated to the areas 2 and 4 are used to perform the backward-direction record-scanning operation. Although the above-described two-column thinning method is exemplarily used in the first embodiment, another method can be used without being limited to the first embodiment so long as data-thinning processing and the record-scanning direction are ensured.

Next, time-difference unevenness reduction control performed according to the first embodiment will be described. In the first embodiment, conveyance control (sub-scanning control) disclosed in U.S. Pat. No. 5,500,661 is performed to keep the order in which inks are superimposed on one another in a record region constant. However, according to the method disclosed in U.S. Pat. No. 5,500,661, the time-difference unevenness is caused by the time difference between the preceding dotting and the following dotting. Therefore, the time-difference unevenness reduction control is also performed in the first embodiment. The time-difference unevenness reduction control causes the recording ratio between the preceding dotting and the following dotting to be variable in units of certain image-data regions to reduce the time-difference unevenness occurring in image data. That is to say, it becomes possible to make the recording ratio between the preceding dotting and the following dotting variable by controlling the ratio between the forward-direction recording and the backward-direction recording for each conveyance region.

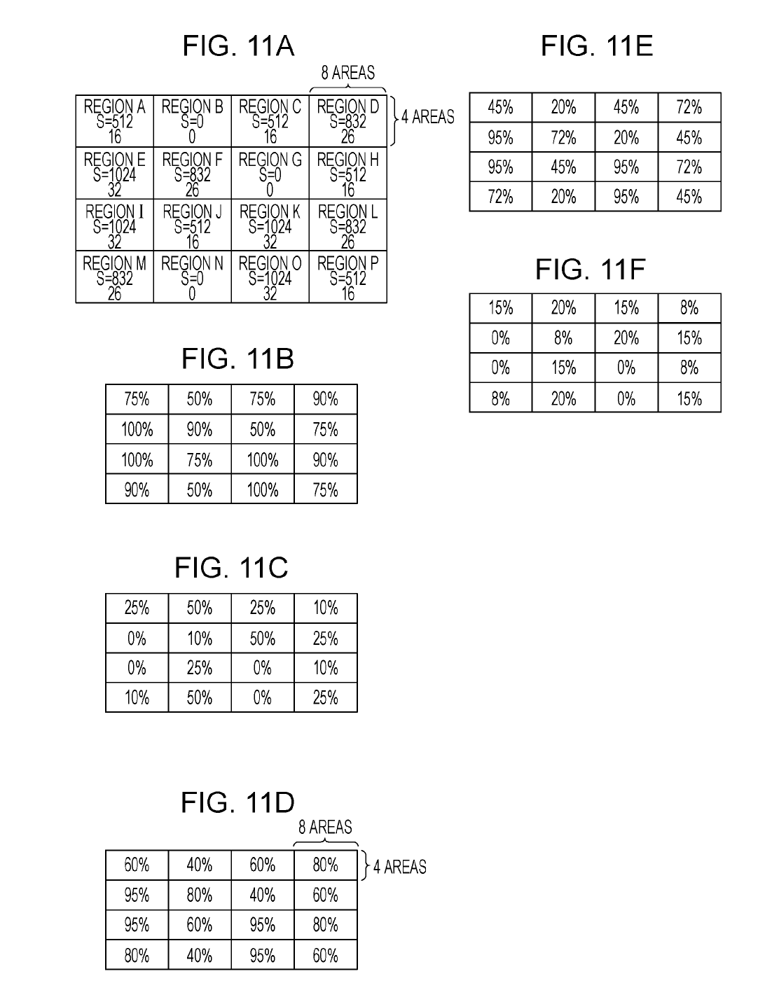

Here, the term “conveyance region” denotes a unit region for which recording is completed by performing the record-scanning operation certain times according to the recording system disclosed in U.S. Pat. No. 5,500,661. In the first embodiment, the conveyance region is a region the size of 4 by 4 pixels arranged along the sub-scanning direction (FIG. 11), for which data recording is completed through four scans. Hereinafter, the conveyance region will be described with reference to the drawings.

FIGS. 7A and 7B schematically illustrate dot-arrangement pattern data used in the first embodiment. Levels illustrated in FIGS. 7A and 7B indicate the levels of quantized pixel data. Here, the relationship between the dot arrangement and the recording direction is illustrated based on a pattern data in level 1 and that in level 2.

FIG. 7A illustrates index-pattern data group A including four types of index-pattern data I to IV including pattern data 701 and 702, 703 and 704, 705 and 706, and 707 and 708 indicating record data allocated into a matrix M including two horizontal areas by two vertical areas. FIG. 7B illustrates index-pattern data group B includes four types of index-pattern data V to VIII including pattern data 709 and 710, 711 and 712, 713 and 714, and 715 and 716 indicating record data allocated into the matrix M including two horizontal areas by two vertical areas.

Here, in the index-pattern data group A, the pattern data 701, 703, 705, and 707 correspond to level 1, and the pattern data 702, 704, 706, and 708 correspond to level 2. Likewise, in the index-pattern data group B, the pattern data 709, 711, 713, and 715 correspond to level 1, and the pattern data 710, 712, 714, and 716 correspond to level 2. As for the pattern data corresponding to level 1, a single record data item is allocated to the matrix M, while two record data items are allocated to the matrix M for the pattern data items corresponding to level 2. Here, the quantized pixel data is in three levels of from 0 to 2 as stated above, and no record data is allocated into the matrix M when the quantized pixel data is in level 0.

In the index-pattern data group A illustrated in FIG. 7A, record data is allocated to any one of the areas 1, 2, 3, and 4 of the matrix 604 illustrated in FIG. 6 in levels 1 and 2. Therefore, dots are recorded during each of the forward scanning and the backward scanning. Namely, in level 1, a record data item is allocated to each of an area 4 illustrated in the matrix 701 and an area 2 illustrated in the matrix 703 (refer to the matrix M of FIG. 6) so that dots are recorded with the backward scanning based on those record data items. On the other hand, a record data item is allocated to each of an area 3 illustrated in the matrix 705 and an area 1 illustrated in the matrix 707. Consequently, dots are recorded with the forward scanning based on those record data items.

Further, in level 2, a record data item is allocated to each of areas 1 and 4 illustrated in the matrix 702, areas 2 and 3 illustrated in the matrix 704, areas 3 and 4 illustrated in the matrix 706, and areas 1 and 2 illustrated in the matrix 708. Consequently, dots are recorded with the forward scanning and the backward scanning at equal ratio.

On the other hand, in the index-pattern data group B illustrated in FIG. 7B, a record data item is allocated to each of an area 3 illustrated in the matrix 709, an area 1 illustrated in the matrix 711, an area 3 illustrated in the matrix 713, and an area 1 illustrated in the matrix 715 in level 1. Consequently, dots are recorded with the forward scanning based on those record data items. Further, in level 2, a record data item is allocated to each of areas 1 and 3, as illustrated in the matrices 710, 712, 714, and 716. Therefore, dots are recorded with the forward scanning based on those record data items.

Each of the above-described index-pattern data groups A and B includes four types of index-pattern data items. Those pattern data groups are referred to as index-pattern data sets (dot-arrangement pattern data sets). A processing procedure which will be described later is performed to determine which of the index-pattern data items that are included in the index-pattern data set should be selected, and either of the index-pattern data groups A and B is selected based on the determination result. Then, one of the index-pattern data items of the selected index-pattern data group A or B is selected according to a selection method which will be described later, and the matrix corresponding to pixel data is allocated to the selected index-pattern data item. Then, the selected index-pattern data item is expanded as record data.

Next, data processing performed based on the above-described index-pattern data groups A and B will be described with reference to the flow of the data processing procedures illustrated in FIG. 6.

As stated above, the 8-bit RGB-format multi-valued pixel data 601 processed to have a resolution of 600 dpi is converted into the 8-bit CMYK-format pixel data 602. Next, the CMYK pixel data 602 is subjected to the quantization processing and converted into three-level (0 to 2) CMYBk quantization-processing result data 603. An appropriate ratio between the forward-direction recording and the backward-direction recording is determined based on the transmitted multi-valued pixel data 601 as the method of recording data in a certain image data region, and the recording ratio is changed. The recording-direction ratio changing method and a recording-direction ratio change determination method will be described later.

When it is determined that the forward-direction recording ratio should be increased, The ratio of the index-pattern data group B is increased and a pattern data item appropriate for the level of the quantization-processing result is selected from among the index-pattern data group B. In the index-pattern data group A, dots are recorded with the forward scanning and the backward scanning, because the record data is allocated to each of the areas 1, 2, 3, and 4 that are written in the matrix M shown in FIG. 6.

On the other hand, the index-pattern data group B is selected for pixel data determined to be switched to the forward-direction recording based on the determination result of the recording-direction ratio change determination method. Then, a pattern data item appropriate for the level of the pixel data is selected from among the index-pattern data group B. When the result of processing the three-level CMYBk quantization-processing result data 603 indicates level 2 and the index-pattern data V illustrated in FIG. 7B is selected, pixel pattern data is expanded based on the pattern data 710. Since record data is allocated to the areas 1 and 3, dots are recorded only with the forward scanning based on the record data. The method of selecting the index-pattern data I to IV and the index-pattern data V to VIII will be described later.

Thus, a recording system including a combination of the record-data generation method and the division recording method achieved by dividing the recording scanning operation into the plurality of record scanning operations is adopted. Consequently, it becomes possible to select a record-scanning direction for each matrix including certain pixels (two horizontal areas by two vertical areas in the first embodiment).

Next, the above-described recording-direction ratio changing method will be described. First, an index-pattern selection threshold matrix provided to select either of the index-pattern data groups A and B is set in a certain image-data region. In the first embodiment, the certain image-data region includes eight horizontal pixels by four vertical pixels.

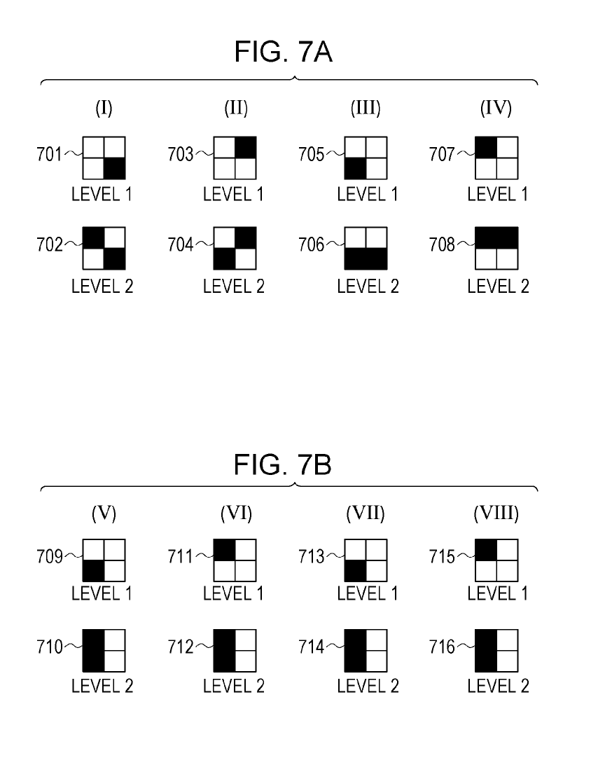

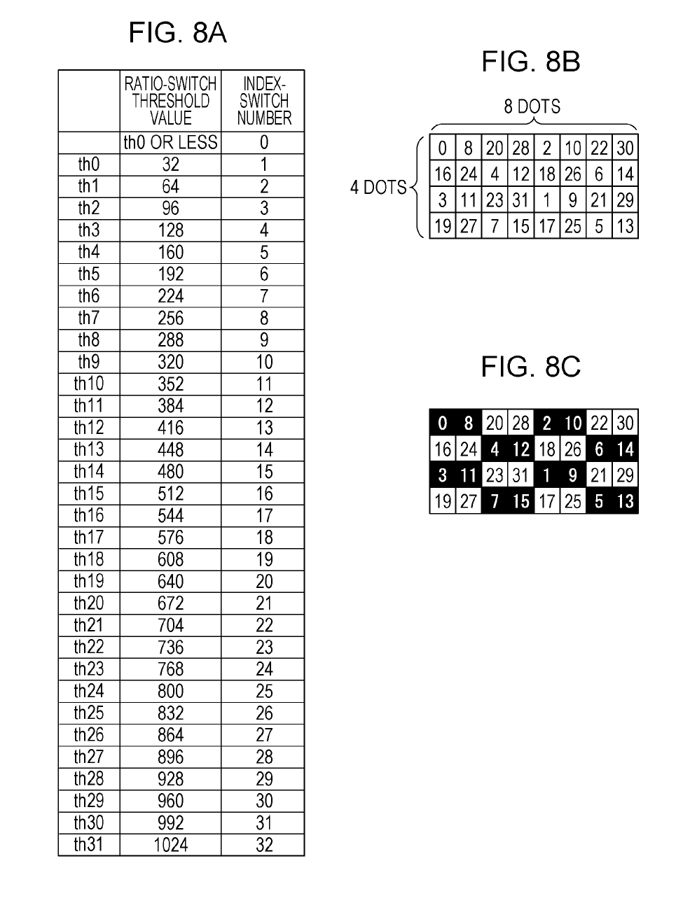

FIG. 8A is a threshold table provided to determine the number of pixels for index switching, the pixels being included in the certain image-data region. The threshold table shows thirty-one threshold values. FIG. 8B illustrates an index-pattern group selection threshold matrix provided for eight horizontal pixels by four vertical pixels. Threshold numbers 0 to 31 are assigned to the pixels provided at thirty-two positions. A determination value derived from a multi-valued pixel input value according to a determination method which will be described later is compared to the thirty-one threshold values illustrated in the threshold table, and the number of pixels that should be switched to the index-pattern data group B is determined. The pixels that should be switched to the index-pattern data group B are selected from the index-pattern group selection matrix based on the determined pixel number. When the determination value is 520, for example, the determination value exceeds a threshold value th15 illustrated in FIG. 8A. Therefore, the number of pixels that should be switched to the index-pattern data group B is sixteen. The sixteen pixels for switching are provided at pixel positions 0 to 15 illustrated in the index-pattern group selection matrix.

FIG. 8C schematically illustrates the positions of pixels that should be switched to the index-pattern group B. In FIG. 8C, solidly shaded pixels are switched to the index-pattern data group B. As a result, the ratio between the index-pattern data groups A and B stands at 1:1. When all of the pixels of the certain image-data region are in level 1 or level 2, dots are recorded at a 50%-to-50% forward direction-to-backward direction ratio for the index-pattern data group A, and at a 100%-to-0% forward direction-to-backward direction ratio for the index-pattern data group B. Consequently, for the certain image-data region, dots are recorded at a 75%-to-25% forward direction-to-backward direction ratio in total. That is, the recording method of the first embodiment allows for recording dots at a 75%-to-25% preceding dotting-to-following dotting ratio.

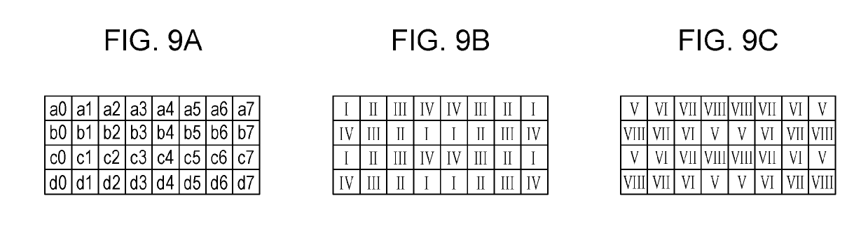

Next, the flow of binary expansion performed based on the index-pattern data will be described. The method of selecting an arbitrary index pattern from among an index-pattern group including a plurality of index patterns will be described. FIG. 9A schematically illustrates the positions of data illustrated in the region corresponding to eight horizontal pixels by four vertical pixels. FIG. 9B illustrates the index selection table A corresponding to the index-pattern data group A, and FIG. 9C illustrates the index selection table B corresponding to the index-pattern data group B.

As for a pixel determined to be subjected to the binary expansion based on the index-pattern data group A after the above-described index-switching determination procedures, any one of the index-pattern data I to IV that are illustrated in FIG. 7A is selected, and the binary expansion is performed. Further, as for a pixel determined to be subjected to the binary expansion based on the index-pattern data group B, any one of the index-pattern data V to VIII that are illustrated in FIG. 7B is selected, and the binary expansion is performed. A plurality of index-pattern data items used to perform the binary expansion is selected based on an index selection table A or an index selection table B.

For example, when the number of pixels that should be switched to the index-pattern data group B is determined to be sixteen, a pixel position 12 illustrated in FIG. 8C corresponds to a pixel b3 illustrated in FIG. 9A, for example, and the index-pattern group B is selected. Therefore, with reference to the index selection table B illustrated in FIG. 9C, which corresponds to the index-pattern data group B, the use of the index-pattern data V is determined. The dot-arrangement pattern is selected from among the index-pattern data V based on transmitted level data, and the binary expansion is performed.

Thus, the dot-arrangement pattern is selected from among the index-pattern data based on the index selection table. Consequently, it becomes possible to avoid the repetition of a certain dot arrangement and reduce the occurrence of texture exerting a harmful effect on the image quality.

### Recording-Direction Ratio Change Determination Method 1

Next, a preceding dotting-to-following dotting ratio change determination method performed to determine an appropriate ratio between the above-described preceding-dot recording and following-dot recording will be described. Here, a recording-direction ratio change determination method performed in consideration of the application amount of ink of each color and a weight assigned to each color in relation to the time-difference unevenness based on input multi-valued data will be described.

As for multi-valued (0 to 255) pixel data corresponding to the ink colors, the pixel data being stored in a certain image-data region (eight horizontal pixels by four vertical pixels), an input cyan-pixel value is determined to be Vc, an input magenta-pixel value is determined to be Vm, an input yellow-pixel value is determined to be Vy, and an input black-pixel value is determined to be Vk. Further, in relation to the weight assignment performed for each color, the weight assignment being indicated by the sign N, the cyan weight assignment is determined to be Nc, the magenta weight assignment is determined to be Nm, the yellow-weight assignment is determined to be Ny, and the black weight assignment is determined to be Nk. The assignments are set in consideration of the degree of contribution of each ink to the time-difference unevenness. When a reduced value calculated based on the input pixel value of each ink color, the input pixel value being input for an arbitrary single pixel, and the weighting coefficient N of the input pixel value is determined to be Kn (n=integer), the reduced value Kn is obtained by Equation (1).

Kn=Nc×Vc+Nm×Vm+Ny×Vy+Nk×Vk (1)

Here, the reduced value Kn is calculated according to Equation (1) for each of thirty-two pixels that are provided in the certain image-data region. A determination value S used to determine the index-switch number of the certain image-data region is determined to be the average of the reduced values Kn of the thirty-two pixels as illustrated in Equation (2).

$$S = \frac{{\sum }_{n = 0} Kn}{32} ( n = 0 , 1 , … 31 ) \qquad ( 2 )$$

In the first embodiment, an ink which is likely to cause the time-difference unevenness is provided with an increased weighting coefficient and an ink which is not likely to cause the time-difference unevenness is provided with a decreased weighting coefficient, placing more importance on the degree of contribution of each ink to the occurrence of time-difference unevenness than that placed on the result of an experiment conducted in advance. More specifically, the weighting coefficients are determined as illustrated by the following equations: Nc=1.3, Nm=1.0, Ny=1.5, and Nk=0.7. For example, an example where an input pixel having input pixel values Vc=210, Vm=128, Vy=32, and Vk=16 processes sixteen input values and an input pixel having input pixel values Vc=160, Vm=100, Vy=128, and Vk=64 processes sixteen input values in a certain image-data region will be considered. In that case, the determination value S calculated based on the input pixel value of each ink color and the weight thereof becomes 502, and the calculated determination value S is compared to the threshold table illustrated in FIG. 8A to determine the index-switch number. Since the calculated determination value S falls within a range of from a threshold value th14 to the threshold value th15, the index-switch number is fifteen.

When it is determined that the time-difference unevenness may occur in the certain image-data region due to the multi-valued input value as described above, the number of data items of the index-pattern data groups A and B, which are provided in a certain region arbitrary determined, is caused to be variable based on the determination value S calculated based on the input pixel value of each ink color and the weight thereof, and the threshold table. As a consequence, the recording ratio between the preceding dotting and the following dotting can be changed in units of certain regions for recording.

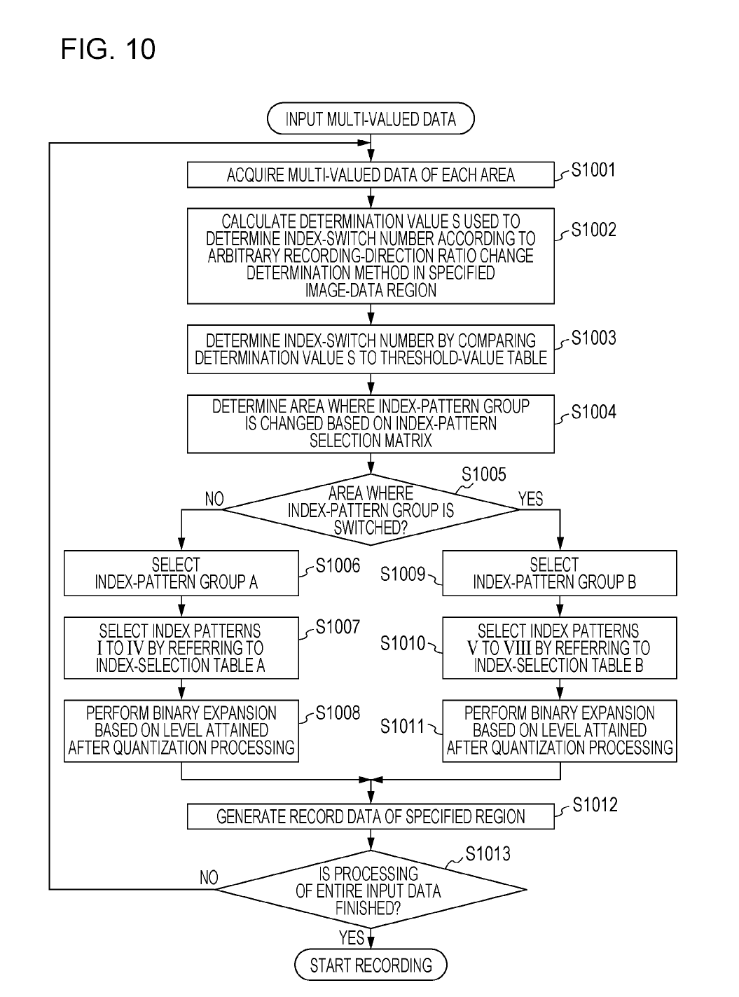

FIG. 10 is a flowchart illustrating processing procedures that are performed to generate record data by using the above-described functions. Input multi-valued data items are acquired at step S1001. At step S1002, the determination value S used to determine the index-switch number according to the above-described arbitrary recording-direction ratio change determination method is calculated in a certain image-data region based on ink-color input pixel values that are input at step S1001.

At step S1003, the determination value S calculated at step S1002 is compared to thirty-one threshold values, the threshold values being illustrated in the threshold table, and the number of pixel(s) that should be switched to the index-pattern data group B is determined. At step S1004, the pixel(s) subjected to the index-pattern switching is determined with reference to the number of pixel(s) that should be switched to the index-pattern data group B, the number being determined at step S1003, and the index-pattern group selection matrix. At step S1005, it is determined whether or not the index-pattern data group should be switched to another for each of the pixels that are provided in the certain region based on the result of the determination made at step S1004.

When it is determined that the index-pattern data group should not be switched to another at step S1005, the index-pattern data group A is selected at step S1006. At step S1007, reference is made to the index selection table A and the corresponding index-pattern data I to IV are selected. At step S1008, the binary expansion is performed based on the index-pattern data items that are selected at step S1007 and the quantization result.

On the other hand, when it is determined that the index-pattern data group should be switched to another at step S1005, the index-pattern data group B is selected at step S1009. At step S1010, reference is made to the index selection table B, and the corresponding index-pattern data V to VIII are selected. At step S1011, the binary expansion is performed based on the index-pattern data items that are selected at step S1110 and the quantization result. At step S1012, data of the binary-expansion results that are attained at steps S1008 and S1011 is generated as the record data of the certain region. At step S1013, it is determined whether or not all of the input data items are processed and the dot recording is started.

FIG. 11A illustrates the results of determining the number of pixels that should be switched to the index-pattern data group B in units of certain regions (eight horizontal pixels by four vertical pixels) based on the flowchart of FIG. 10 by comparing dot-forming ratio determination values S of regions A to P to the threshold table. The region is shown on the upper line, the determination value S is shown on the middle line, and the pixel number is shown on the lower line. For the sake of simplicity, it is determined that the number of discharge ports (nozzle number) of the recording head 5 is 12, the conveyance region includes thirty-two horizontal pixels by sixteen vertical pixels, and each of the pixel data items of input image data of a resolution of 600 dpi is recorded.

Here, the binary expansion is performed based on the determined index-pattern group switch number. At that time, the preceding dotting-recording ratio of each of the regions is as illustrated in FIG. 11B. On the other hand, the following dotting-recording ratio of each of the regions is as illustrated in FIG. 11C. FIG. 11D illustrates the full dot duties of the ink colors, which are achieved before the recording-ratio control of the first embodiment is performed. FIG. 11E illustrates the recording duty of each of the regions, which is achieved at the preceding dotting-recording time, where the recording duties are obtained based on the full dot duties illustrated in FIG. 11D and the recording ratios illustrated in FIG. 11B. FIG. 11F illustrates the recording duty of each of the regions, which is achieved at the following dotting-recording time, where the recording duties are obtained based on the full dot duties illustrated in FIG. 11D and the recording ratios illustrated in FIG. 11C.

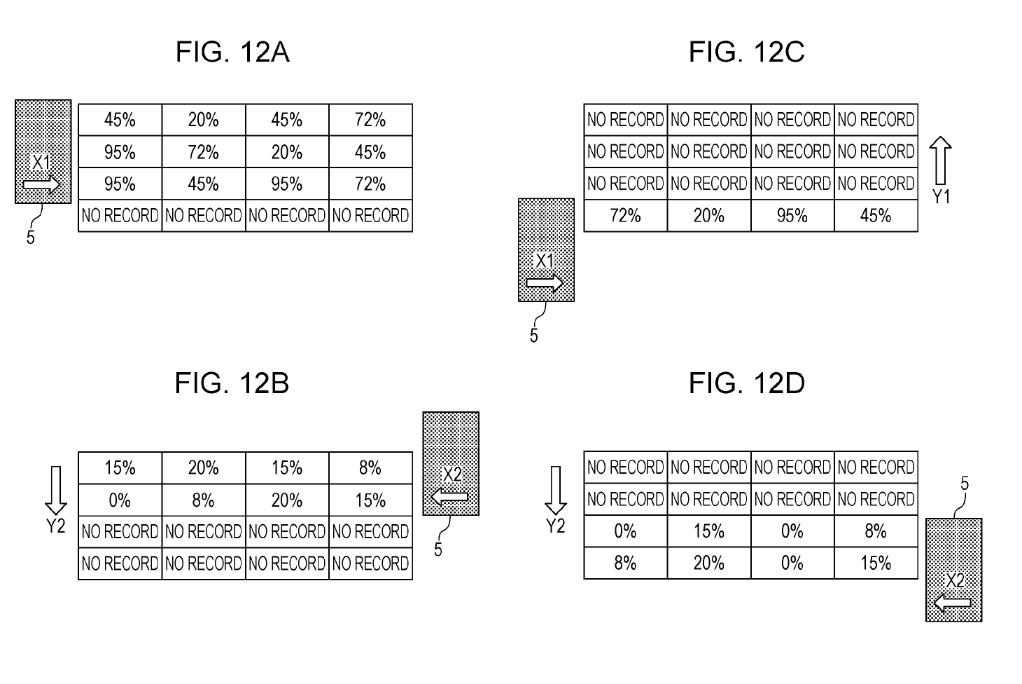

FIG. 12 illustrates the method of recording the record data subjected to the binary expansion through the processing procedures that are illustrated in FIGS. 11A to 11F by performing a recording operation that causes the recording order to be constant in any record region through conveyance control including the backward conveyance of a recording medium. Here, a recording head H including twenty-four nozzles along its entire length conveys a record sheet in a normal conveyance direction (Y1 direction) by as much as thirty-two nozzles, and conveys the record sheet in a backward conveyance direction (Y2 direction) by as much as eight nozzles, where the recording head H performs the normal-direction conveyance and the backward-direction conveyance alternately and repeatedly so that the recording order becomes constant in any of the record regions.

FIG. 12A illustrates the recording operation corresponding to the first scan, and the operation direction of the recording head H is the forward direction (X1 direction). At that time, data is recorded on the regions A to L illustrated in FIG. 11A, and the recording duties of the regions are as illustrated in FIG. 11E. Next, the record sheet is conveyed (Y2 direction) and the recording head H travels to a position indicated by FIG. 12B.

FIG. 12B illustrates the recording operation performed for the second scan, and the operation direction of the recording head H is the backward direction (X2 direction). At that time, data is recorded on the regions A to H illustrated in FIG. 11A, and the recording duties of the regions are as illustrated in FIG. 11F. Next, the record sheet is conveyed (Y1 direction) and the recording head H travels to a position indicated by FIG. 12C.

FIG. 12C illustrates the recording operation performed for the third scan, and the operation direction of the recording head H is the forward direction (X1 direction). At that time, data is recorded on the regions M to P illustrated in FIG. 11A, and the recording duties of the regions are as illustrated in FIG. 11E. Next, the record sheet is conveyed (Y2 direction) and the recording head H travels to a position indicated by FIG. 12D.

FIG. 12D illustrates the recording operation performed for the fourth scan, and the operation direction of the recording head H is the backward direction (X2 direction). At that time, data is recorded on the regions I to P illustrated in FIG. 11A, and the recording duties of the regions are as illustrated in FIG. 11F.

Thus, it becomes possible to cause the recording-duty ratio between the preceding dotting and the following dotting to be variable based on the data values input for each region. When it is determined that no time-difference unevenness occurs in a given region, dots are recorded for the given region in the forward direction and the backward direction at equal ratio through 2-pass division recording. On the other hand, when it is determined that the time-difference unevenness occurs in another given region, the preceding dotting-recording ratio is increased to be higher than the following dotting-recording ratio. As a consequence, it becomes possible to reduce the time-difference unevenness caused by the differing recording order, which occurs at the two-way-recording time. Further, in the first embodiment, the preceding dotting-recording ratio and the following dotting-recording ratio are changed in stages based on the susceptibility of the time-difference unevenness to occur (the application amount of ink).

In the first embodiment, the preceding dotting-recording ratio is increased to be higher than the following dotting-recording ratio in a region where the time-difference unevenness easily occurs. However, on the other hand, the preceding dotting-recording ratio may be decreased to be lower than the following dotting-recording ratio. That is, in the first embodiment, the difference between the preceding dotting-recording ratio and the following dotting-recording ratio, which is obtained in a region where the ink-application amount is relatively large and the time-difference unevenness easily occurs, is increased to be higher than that obtained in a region where the ink-application amount is relatively small and the time-difference unevenness hardly occurs. Consequently, it becomes possible to reduce the time-difference unevenness.

However, the time-difference unevenness can be reduced more effectively by increasing the preceding dotting-recording ratio to be higher than the following dotting-recording ratio as below.

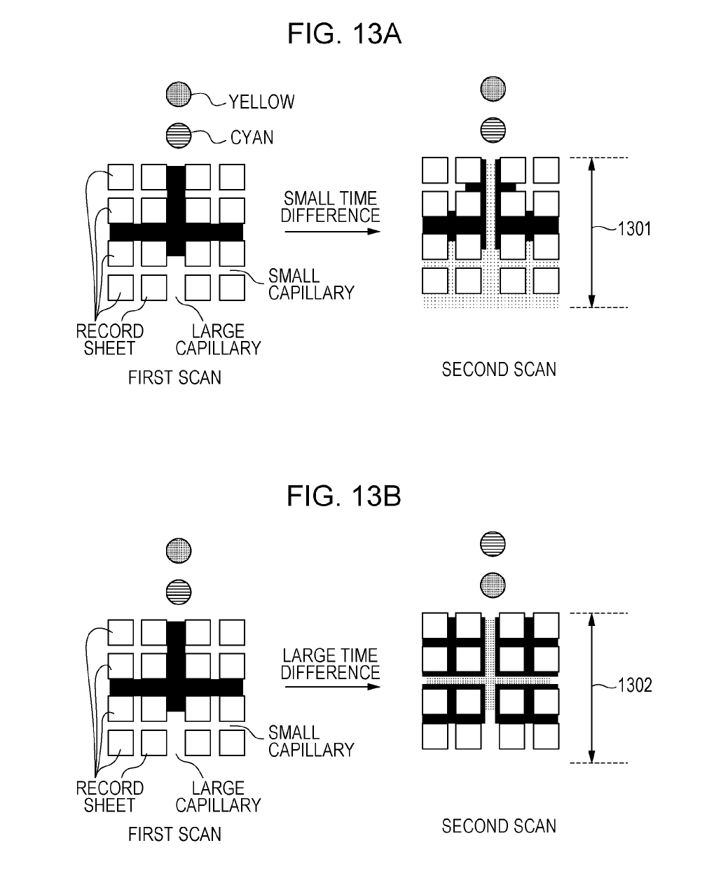

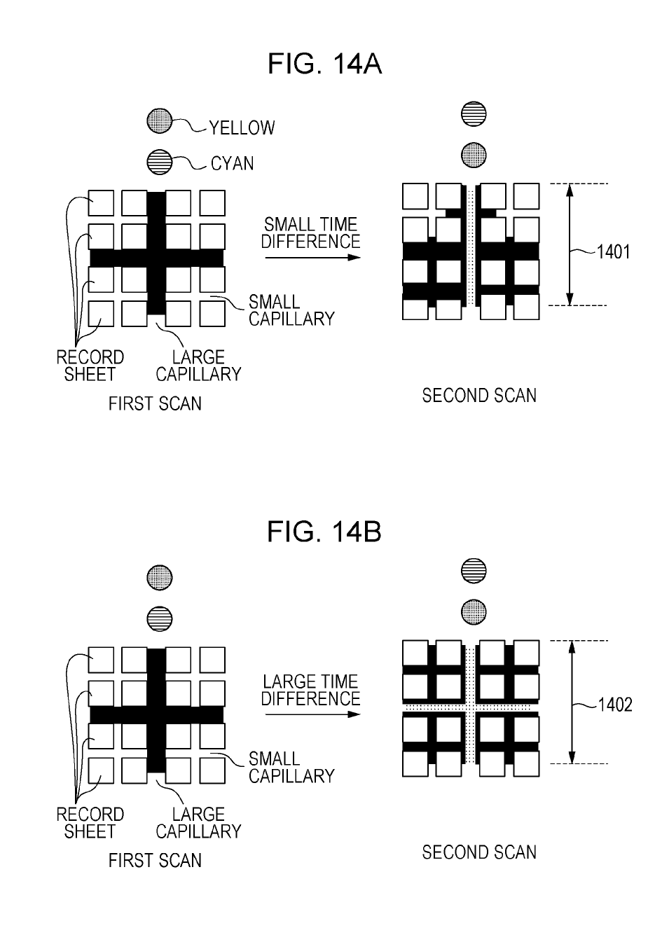

FIGS. 13A and 13B, and 14A and 14B are provided to illustrate the mechanism for causing the color development to differ from band to band, the color-development difference being caused by the time difference between scans. Each of the FIGS. 13A to 14B schematically illustrates a modeled record sheet, and large and small capillaries included in the record sheet. FIGS. 13A and 13B schematically illustrate the case where dots are recorded at equal duty ratio for each scan. FIG. 13A illustrates a first recording medium-conveyance region and FIG. 13B illustrates a state of a second recording medium-conveyance region located near the first recording medium-conveyance region.

First, when a cyan-ink droplet and a yellow-ink droplet land on the record sheet in that order for the first scan in the first recording medium-conveyance region illustrated in FIG. 13A, the ink droplets are absorbed through the large capillary. Next, when another yellow-ink droplet and another cyan-ink droplet land on the record sheet in that order for the second scan without allowing the recording time difference, the ink droplets penetrate into the record sheet around the ink droplets recorded with the first scan and are fused onto the record sheet. The depth of the above-described penetration is illustrated with reference numeral 1301.

On the other hand, when another cyan-ink droplet and another yellow-ink droplet land on the record sheet in that order for the first scan in the second recording medium-conveyance region illustrated in FIG. 13B, the ink droplets are absorbed through the large capillary. Next, when another yellow-ink droplet and another cyan-ink droplet land on the record sheet in that order for the fourth scan with a sufficient recording time difference between the scans, the ink droplets recorded for the first scan reach the small capillary and are absorbed into the record sheet. Accordingly, the ink droplets recorded for the second scan penetrate into the large capillary provided on the surface layer of the record sheet and are fused onto the record sheet. The depth of the above-described penetration is illustrated with reference numeral 1302. The difference between the penetration depths 1301 and 1302 causes the color-development difference so that the time-difference unevenness occurs.

Next, the advantage of the first embodiment will be described with reference to FIGS. 14A and 14B. FIG. 14A illustrates a first recording medium-conveyance region and FIG. 14B illustrates a state of a second recording medium-conveyance region located near the first recording medium-conveyance region. First, when a cyan-ink droplet and a yellow-ink droplet land on the record sheet in that order for the first scan in the first recording medium-conveyance region illustrated in FIG. 14A, the ink droplets are absorbed through the large capillary. Next, when another yellow-ink droplet and another cyan-ink droplet land on the record sheet in that order for the second scan without allowing any recording time difference, the ink droplets penetrate into the record sheet around the ink droplets recorded with the first scan and are fused onto the record sheet. The depth of the above-described penetration is illustrated with reference numeral 1401. At that time, the amount of ink used for the second scan performed for the region determined to be a region where the time-difference unevenness occurs is decreased so that the ink is fused at a position nearer to the surface layer of the record sheet than in the case of FIG. 13A.

On the other hand, when another cyan-ink droplet and another yellow-ink droplet land on the record sheet in that order for the first scan in the second recording medium-conveyance region illustrated in FIG. 14B, the ink droplets are absorbed through the large capillary. Next, when another yellow-ink droplet and another cyan-ink droplet land on the record sheet in that order for the fourth scan with a sufficient recording time difference between the scans, the ink droplets recorded with the first scan reach the small capillary and are absorbed into the record sheet. Accordingly, the ink droplets recorded with the second scan penetrate into the large capillary provided on the surface layer of the record sheet and are fused onto the record sheet. The depth of the above-described penetration is illustrated with reference numeral 1402. Since the difference between the penetration depths 1401 and 1402 is smaller than that between the penetration depths 1301 and 1302, the color-development difference is decreased. Further, unevenness caused by the time difference between the scans performed for the first and second recording-medium conveyance regions is decreased.

Thus, the degree of the time-difference unevenness occurrence, which is obtained at the forward recording time, is determined in units of certain regions to which data is input, and the index-pattern data specifying a recording direction for a region where the time-difference unevenness easily occurs is set. Consequently, it becomes possible to control an appropriate recording ratio between the preceding dotting and the following dotting that are performed to record data in each region and decrease the time-difference unevenness during the recording operation causing the recording order to be constant in any record region by performing the conveyance control including the backward recording-medium conveyance.

In the first embodiment, the certain image-data region including four vertical pixels by eight horizontal pixels is determined to be a single unit to determine the recording ratio between the forward direction and the backward direction. However, the recording ratio between the forward direction and the backward direction may be determined for each pixel region by comparing the value of input image data to the threshold value for each pixel region without referring to the index-pattern group selection matrix. Although the recording method achieved by performing the conveyance control including the conveyance performed in the forward direction of the conveyance direction and the backward conveyance performed in the backward direction is exemplarily described in the first embodiment, another embodiment of the present invention may be achieved without being limited to the above-described recording method.

Namely, the present invention has been achieved to reduce the time-difference unevenness caused by the differing time difference between the scan performed for the preceding dotting recording and that performed for the following dotting recording, so as to be used for systems where the above-described problem occurs. That is, in the first embodiment where regions (first and second regions) different from each other in the number of the preceding dotting-recording operations (the first scan) and that of the following dotting-recording operations (the second scan) occur, the difference between the forward-direction recording ratio and the backward-direction recording ratio should be relatively large in a region where the time-difference unevenness easily occurs.

### Second Embodiment

Next, a second embodiment of the present invention will be described. The configurations illustrated in FIGS. 1 to 3 are also used for the second embodiment.

In the second embodiment, a method of reducing the time-difference unevenness with increased precision in consideration of the time difference occurring in the main-scanning direction (carriage-drive direction) in addition to the time difference between the preceding dotting recording and the following dotting recording will be described. Namely, the recording ratio is set in consideration of the position of each image-data region in the main-scanning direction. In the second embodiment, record data is generated and processed according to the same method as that of the first embodiment.

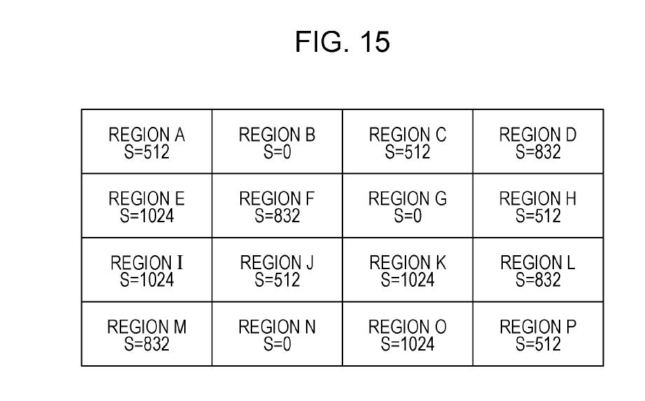

FIG. 15 illustrates a record-data processing method used in the second embodiment. A result of determining the time-difference unevenness determination value S for each of pixel data items of input image data of a resolution of 600 dpi, the input image data having the input-image size corresponding to thirty-two horizontal pixels by sixteen vertical pixels, in units of certain regions (eight horizontal pixels by four vertical pixels) is illustrated.

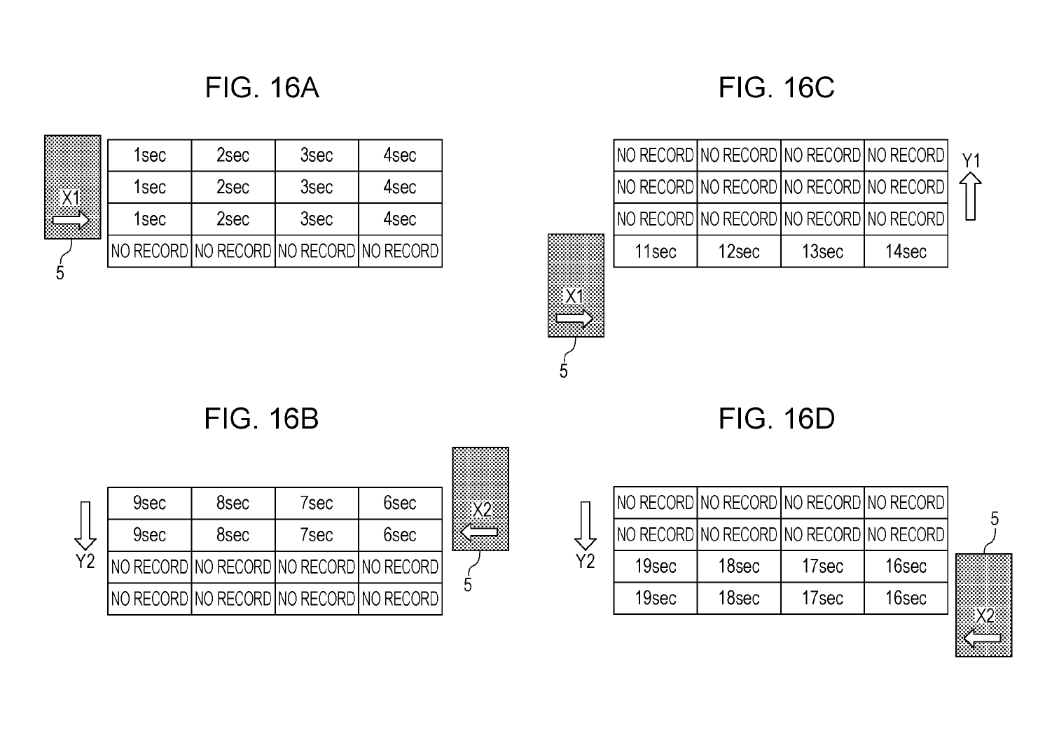

Each of FIGS. 16A, 16B, 16C, and 16D illustrates the elapsed time consumed until data is recorded onto each region according to the recording method of the second embodiment. It is determined that the recording start time is 0 sec, and 1 sec is consumed until a carriage travels by as much as the eight horizontal pixels, and 1 sec is consumed to convey the recording medium. Each of FIGS. 16A and 16C illustrates a scan achieved by performing the preceding dotting for each region, where FIG. 16A illustrates the first scan and FIG. 16C illustrates the third scan. FIG. 16A illustrates times consumed to perform the recording corresponding to the first scan and FIG. 16C illustrates times consumed to perform the recording corresponding to the third scan. Each of FIGS. 16B and 16D illustrates a scan achieved by performing the following dotting for each image region, where FIG. 16A illustrates the second scan and FIG. 16C illustrates the fourth scan. FIG. 16B illustrates times consumed to perform the recording corresponding to the second scan and FIG. 16D illustrates times consumed to perform the recording corresponding to the fourth scan.

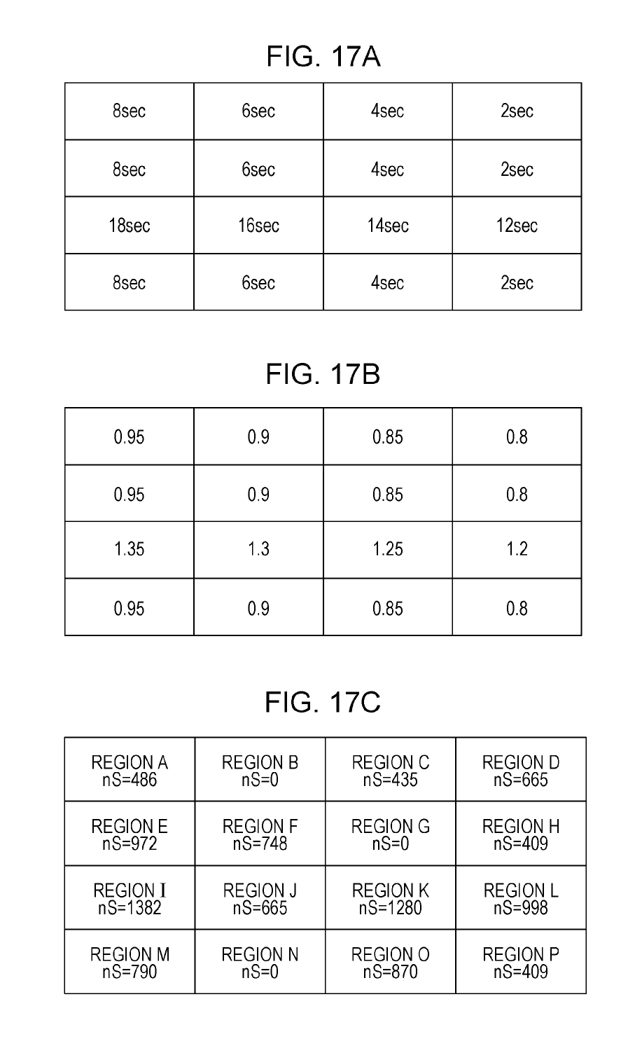

FIGS. 17A to 17C illustrate a main-scanning time difference table used in the second embodiment. FIG. 17A illustrates the main-scanning direction time difference between the time when the preceding dotting recording is performed and the time when the following dotting recording is performed, the time difference being obtained in each of the image regions illustrated in FIG. 16. FIG. 17B illustrates a main-scanning direction time-difference weighting coefficient n set to each region in consideration of the main-scanning direction time differences illustrated in FIG. 17A. FIG. 17C illustrates a result of multiplying the time-difference unevenness determination values S illustrated in FIG. 15 by the main-scanning direction time-difference weighting coefficients n set in FIG. 17B. In the second embodiment, each of values nS is determined to be a final determination value and used to determine the number of pixel(s) which should be switched to the index-pattern data group B.

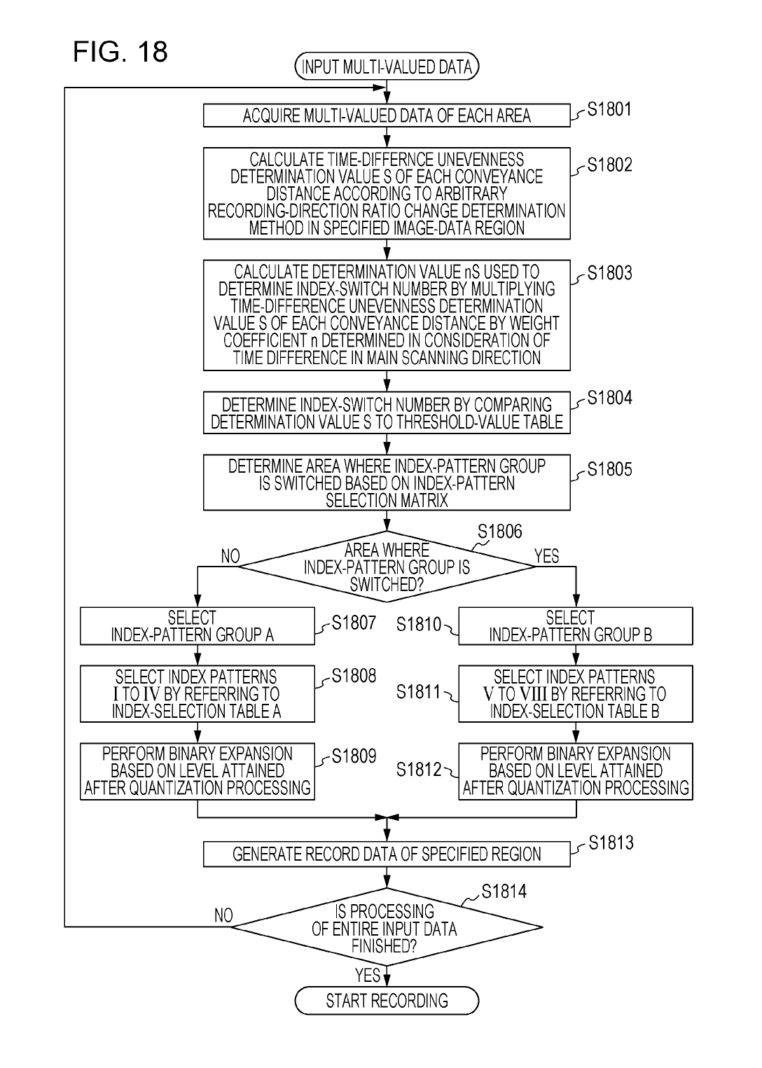

FIG. 18 is a flowchart relating to processing procedures that are performed to generate record data by using the above-described functions. At step S1801, input multi-valued data items are acquired. At step S1802, the determination value S is calculated according to the above-described arbitrary recording-direction ratio change determination method in a certain image-data region based on ink-color input pixel values that are input at step S1801. At step S1803, the determination value nS used to determine the index-switch number is calculated by multiplying the time-difference unevenness determination value S calculated at step S1802 by the weighting coefficient n obtained in consideration of the main-scanning direction time difference.

At step S1804, the determination value nS calculated at step S1803 is compared to thirty-one threshold values, the threshold values being illustrated in the threshold table of FIG. 8A, to determine the number of pixel(s) that should be switched to the index-pattern data group B. At step S1805, the pixel(s) subjected to the index-pattern switching is determined with reference to the number of pixel(s) that should be switched to the index-pattern data group B, the number being determined at step S1804, and the index-pattern group selection matrix. At step S1806, it is determined whether or not the index-pattern data group should be switched to another for each of the pixels that are provided in the certain region based on the result of the determination made at step S1805.

When it is determined that the index-pattern data group should not be switched to another at step S1806, the index-pattern data group A is selected at step S1807. At step S1808, reference is made to the index selection table A and the corresponding index-pattern data I to IV are selected. At step S1809, the binary expansion is performed based on the index-pattern data items that are selected at step S1808 and the quantization result.

On the other hand, when it is determined that the index-pattern data group should be switched to another at step S1806, the index-pattern data group B is selected at step S1810. At step S1811, reference is made to the index selection table B, and the corresponding index-pattern data V to VIII are selected. At step S1812, the binary expansion is performed based on the index-pattern data items that are selected at step S1811 and the quantization result. At step S1813, data of the binary-expansion results that are obtained at steps S1809 and S1812 is generated as the record data of the certain region. At step S1814, it is determined whether or not all of the input data items are processed and the dot recording is started.

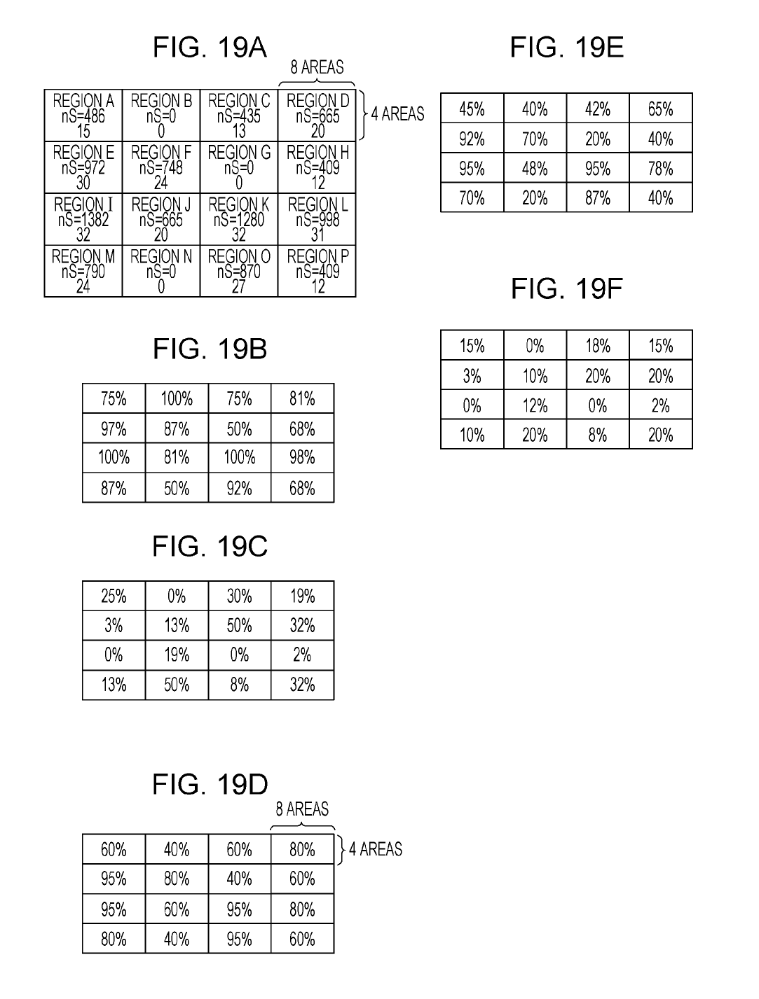

FIGS. 19A to 19F are provided to schematically illustrate processing procedures that are performed to generate record data provided in a certain region according to the second embodiment. FIG. 19A illustrates a result of determining the number of pixel(s) which should be switched to the index-pattern data group B. For each of pixel data items of input image data of a resolution of 600 dpi, the input image data corresponding to thirty-two horizontal pixels by sixteen vertical pixels, the time-difference unevenness determination values nS of the regions A to P are compared to the threshold table illustrated in FIG. 11C in units of certain regions according to the flowchart of FIG. 18. Then, the binary expansion is performed based on the determined index-pattern group switch number.

At that time, the preceding dotting-recording ratios of the regions are as illustrated in FIG. 19B. On the other hand, the following dotting-recording ratios of the regions are as illustrated in FIG. 19C. FIG. 19D illustrates the full dot duties of the ink colors, which are achieved before the recording-ratio control of the second embodiment is performed. FIG. 19E illustrates the recording duty of each of the regions, which is achieved at the preceding dotting-recording time, where the recording duties are obtained based on the full dot duties illustrated in FIG. 19D and the recording ratios illustrated in FIG. 19B. FIG. 19F illustrates the recording duty of each of the regions, which is achieved at the following dotting-recording time, where the recording duties are obtained based on the full dot duties illustrated in FIG. 19D and the recording ratios illustrated in FIG. 19C. The record data generated based on the preceding dotting-recording duties and the following dotting-recording duties that are illustrated in FIGS. 19E and 19D is recorded according to the recording method used in the first embodiment, which is illustrated in FIGS. 12A to 12D.

As described above, the recording-duty ratio between the preceding dotting and the following dotting is caused to be variable based on a data value input to each region in consideration of the main-scanning direction time difference. Accordingly, it becomes possible to reduce the main-scanning direction time-difference unevenness for each area in addition to each conveyance distance.

### Third Embodiment

Next, a third embodiment of the present invention will be described. The configurations illustrated in FIGS. 1 to 3 are also used for the third embodiment. Here, a method different from the recording-direction ratio change determination method illustrated in the first embodiment will be described. As for the rest such as the flow of the recording-data generation, the same processing procedures as those of the first embodiment will be performed.

### Recording-Direction Ratio Change Determination Method 2

In the third embodiment, a recording-direction ratio change determination method 2 performed in consideration of the hue of input data based on input multi-valued data is adopted. Here, the input multi-valued data is provided as 8-bit (0 to 255 levels of gray) RGB data, for example. However, the input multi-valued data may be of any type, so long as the hue can be identified based on the input data.

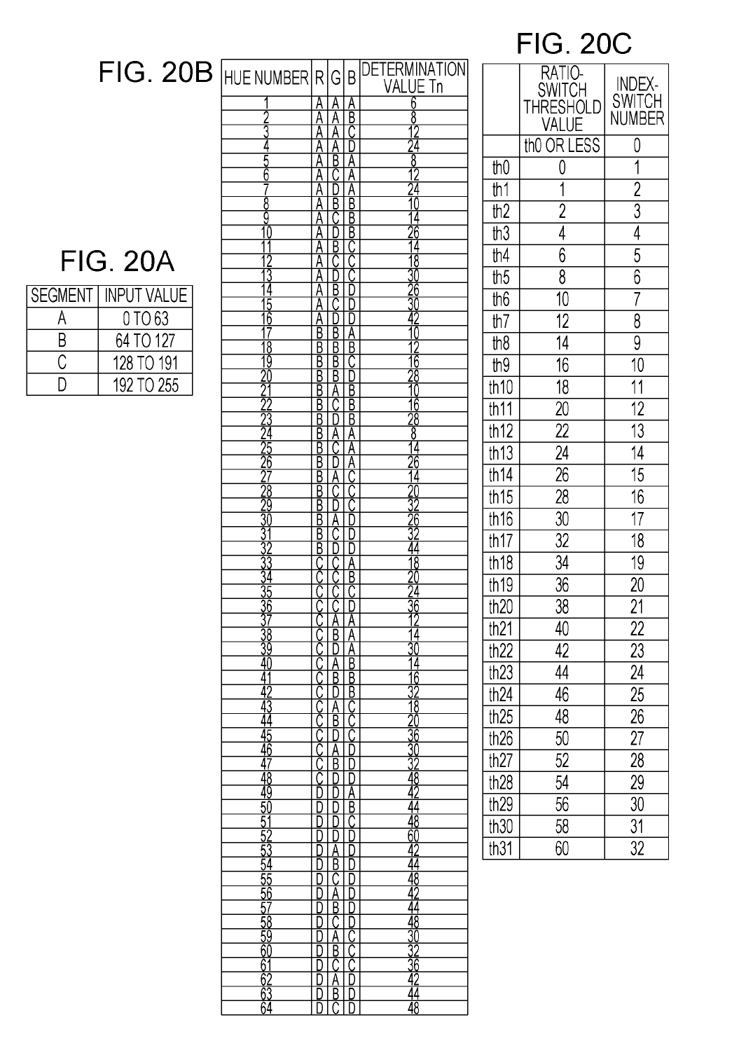

FIGS. 20A, 20B, and 20C illustrate the recording-direction ratio change determination method 2. FIG. 20A illustrates a gray-scale segment table showing input 255-level data items classified under arbitrary gray-scale segments. FIG. 20B illustrates a hue-matrix table specifying the dot-forming ratio determination values corresponding to input RGB-format values. First, 255-level data items are classified under arbitrary gray-scale segments A, B, C, and D. As illustrated in FIG. 20A, the gray-scale segment A corresponds to the 255-level data items 0 to 63, the gray-scale segment B corresponds to the 255-level data items 64 to 127, the gray-scale segment C corresponds to the 255-level data items 128 to 191, and the gray-scale segment D corresponds to the 255-level data items 192 to 255. As illustrated in FIG. 20B, the hue-matrix table shows combinations of input values of R, G, and B, which allows for classifying the hues under the gray-scale segments A, B, C, and D.

At that time, sixty-four combinations of the input values are attained. Therefore, it becomes possible to classify the sixty-four combinations under sixty-four hues and maintain reduced values Tn (n=integer). The dot-forming ratio determination value S used to determine the index-switch number of a certain image-data region is determined to be the average of the reduced values Tn of the thirty-two pixels as illustrated in Equation (3).

$$S = \frac{{\sum }_{n = 0} Tn}{32} ( n = 0 , 1 , … 31 ) \qquad ( 3 )$$

FIG. 20C illustrates a threshold table provided to determine an index-switch number used to perform the recording-direction ratio change determination method 2. The dot-forming ratio determination value S obtained through the above-described procedure is compared to thirty-one threshold values that are illustrated in the threshold table, and the number of pixel(s) that should be switched to the index-pattern data group B is determined. For example, when RGB-format input values 50, 200, and 100 are input to sixteen pixels, and RGB-format input values 100, 200, 100 are input to sixteen pixels in a certain image-data region, a combination of the RGB-format input values 50, 200, and 100 is classified under the hue number 10, and a combination of the RGB-format input values 100, 200, and 100 is classified under the hue number 23 in accordance with the hue-matrix table illustrated in FIG. 20B. The dot-forming ratio determination value S which is the average of the total thirty-two pixels becomes twenty-seven. The calculated dot-forming ratio determination value S is compared to the threshold table illustrated in FIG. 20C to determine the index-switch number. Since the dot-forming ratio determination value S is from th14 to th15 inclusive, the index switch number becomes fifteen.

Record data is generated by performing the same processing procedures as those of the first embodiment based on the dot-forming ratio determination value S calculated as illustrated in FIGS. 20A to 20C. The method of recording the record data generated according to the third embodiment is the same as that of the first embodiment.

As described above, the third embodiment allows for controlling an appropriate recording ratio between the forward direction and the backward direction in consideration of the hue of each region for recording according to the recording-direction ratio change determination method performed in consideration of the hue of input data based on input multi-valued data. Consequently, it becomes possible to reduce an uneven color occurring when dots are recorded through the forward scanning and the backward scanning that are optimized for each hue, and reduce an increase in the recording time.

### Fourth Embodiment

Next, a fourth embodiment of the present invention will be described. The configurations illustrated in FIGS. 1 to 3 are also used for the second embodiment.

The fourth embodiment allows for controlling the recording ratio between the forward direction and the backward direction in a system which is ready for five (0 to 4) levels of the quantization result by doubling the amount of record data in the main-scanning direction, when compared to the first embodiment. In the first embodiment, the binary expansion is performed for each pixel by using an index-allocation pattern size including two horizontal areas by two vertical areas. Of the two horizontal areas by two vertical areas, there are two areas where dots are recorded in the forward direction, that is, the upper-left area and the lower-left area that are illustrated in FIG. 5.

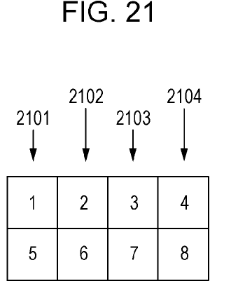

On the other hand, in the fourth embodiment, the resolution of the record data is doubled in the main-scanning direction. In the index pattern including four horizontal areas by two vertical areas, which is illustrated in FIG. 21, columns 2101 and 2103 are odd columns for recording. Therefore, dots are recorded in the forward direction in areas 1, 3, 5, and 7. On the other hand, columns 2102 and 2104 are even columns for recording. Therefore, dots are recorded in the backward direction in areas 2, 4, 6, and 8. Since the recording direction is specified in groups of four areas, it becomes possible to control the recording ratio between the forward direction and the backward direction in each of levels 0 to 5.

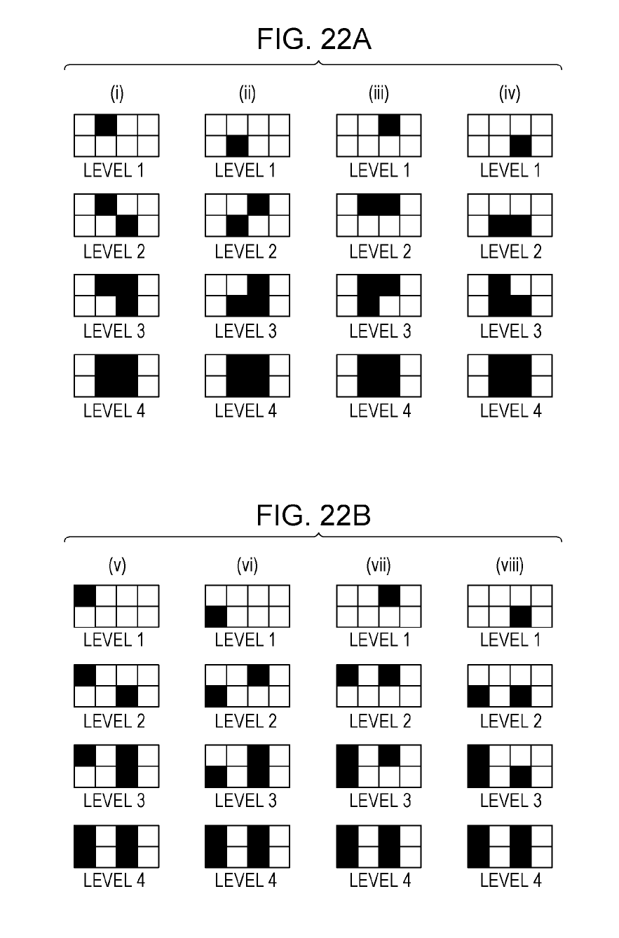

Data is processed in units of certain regions through the same processing procedures as those of the above-described first embodiment. FIGS. 22A and 22B schematically illustrate a plurality of index-pattern data groups according to the fourth embodiment and exemplary index-allocation patterns provided to specify the allocation of index-pattern data to recording pixels. In the first embodiment, binarization is performed for quantization levels 0 to 2 based on index-allocation patterns including two horizontal areas by two vertical areas. On the other hand, in the fourth embodiment, binarization is performed for quantization levels 0 to 4 based on index-allocation patterns including four horizontal areas by two vertical areas. The fourth embodiment will be described with reference to two types of index-pattern groups illustrated in FIGS. 22A and 22B.

FIG. 22A illustrates an index-pattern group A including index patterns i to iv, each of which is provided with index-allocation patterns including four horizontal areas by two vertical areas, the index-allocation patterns corresponding to the quantization results (levels 1 to 4). In the index patterns i to iv, image data is generated for any of the area positions 2, 3, 6, and 7 that are illustrated in FIG. 21. That is, dots are recorded in the column 2102 and/or the column 2103 so that dots are recorded with the forward scanning and the backward scanning.

FIG. 22B illustrates an index-pattern group B including index patterns v to viii, each of which is provided with index-allocation patterns including four horizontal areas by two vertical areas, the index-allocation patterns corresponding to the quantization results (levels 1 to 4). In the index patterns v to viii, image data is generated for any of the area positions 1, 3, 5, and 7 that are illustrated in FIG. 21. That is, dots are recorded in the column 2101 and/or the column 2103 so that dots are recorded with the forward scanning alone.

In the fourth embodiment, the use of those index-pattern groups allows for controlling the recording-direction ratio to the quantization levels 0 to 4 based on the index-allocation patterns including four horizontal areas by two vertical areas.

Processing procedures performed to generate record data in the fourth embodiment are the same as those of the first embodiment, and the generated record data is recorded according to the flowchart illustrated in FIG. 10. The recording operations are also equivalent to those of the first embodiment and as illustrated in FIGS. 12A, 12B, 12C, and 12D.

Thus, the fourth embodiment also allows for causing the forward-direction recording-duty ratio and/or the backward-direction recording-duty ratio based on data values input in units of certain regions. That is, when it is determined that the time-difference unevenness hardly occurs in a given region, dots are recorded onto the given region in the forward direction and the backward direction at equal ratio through the 2-pass division recording. On the other hand, when it is determined that the time-difference unevenness easily occurs in another given region, the forward-direction recording ratio and the backward-direction recording ratio are appropriately adjusted. As a consequence, it becomes possible to reduce the time-difference unevenness caused by the differing recording order occurring at the two-way-recording time. The dot recording is performed for a region where the time-difference unevenness occurs at an appropriate recording ratio between the forward direction and the backward direction while maintaining the scanning of the 2-pass division recording. Accordingly, it becomes possible to reduce the occurrence of the time-difference unevenness while reducing the recording time.

As described above, the fourth embodiment allows for controlling the forward-direction recording ratio and the backward-direction recording ratio corresponding to the five-level (levels 0 to 4) quantization results by doubling the amount of record data in the main-scanning direction.

When the quantization is performed to achieve five values corresponding to levels 0 to 4 in the first embodiment, either of the forward-direction recording ratio and the backward-direction recording ratio is set only to 50% in level 4 where four dots are recorded for two horizontal areas by two vertical areas. On the other hand, the fourth embodiment allows for controlling the recording ratio so that the forward-direction recording ratio can be set to 100% and the backward-direction recording ratio can be set to 0% in level 4. Accordingly, it becomes possible to determine the degree of the time-difference unevenness occurrence, which is obtained at the forward recording time, in units of certain regions to which data is input, and select the index patterns specifying the recording direction in a region where the time-difference unevenness easily occur. Consequently, it becomes possible to reduce the time-difference unevenness occurring when dots are recorded through the forward scanning and the backward scanning, while reducing an increase in the recording time.

### Other Embodiments

In the above-described embodiments, the inkjet recording apparatus is provided with functions as a data processing apparatus according to an embodiment of the present invention, and performs processing including a combination of the binarization performed based on the dot-arrangement pattern data (index-pattern data) and the recording method performed by using the column-thinning method. However, the present invention may be achieved without being limited to the above-described configurations. For example, an inkjet recording apparatus that can distribute data between the preceding dotting recording and the following dotting recording and set record data in a certain region may constitute another embodiment of the present invention.

In the above-described embodiments, a certain region includes eight horizontal pixels by four vertical pixels and the average of the reduced values of the thirty-two pixels is determined to be the determination value S. Further, the determination value S is compared to the thirty-one threshold values illustrated in the threshold table to cause the index-switch number to be variable, so as to control the recording ratio in units of certain regions. However, the size of the certain region and the style of the threshold table are not limited to those of the above-described embodiments. Namely, any system that can change the number of index patterns based on the number of pixel-data items included in the certain-region size to control the recording ratio may constitute another embodiment of the present invention. Further, in the above-described embodiments, the recording method including the backward conveyance of a recording medium, the recording method being disclosed in U.S. Pat. No. 5,500,661 is used. However, without being limited to the above-described embodiments, any recording method by which a time difference occurs between the preceding dotting recording and the following dotting recording for each region may constitute another embodiment of the present invention. For example, a recording method which allows for reducing the time difference between the preceding dotting and the following dotting by performing a carriage-stop operation between recording operations may constitute another embodiment of the present invention.

Further, in each of the above-described embodiments, the recording order may not be constant at all times for the entire area (entire record region) of a single page of a recording medium. Namely, a recording method including the backward conveyance of a recording medium, the backward conveyance being performed only in part of the record region when an uneven recording order is easily viewed in the part, may be adopted.

Further, aspects of the present invention can also be realized by program code realizing the processing procedures of the flowchart illustrated in FIG. 12, which realizes the functions of the above-described embodiments, or a storage medium storing the program code. Still further, a computer (a CPU or MPU) of a computer of a system or apparatus may read and execute the program code stored in the storage medium to achieve another aspect of the present invention. In that case, the program code itself read from the storage medium realizes the functions of the above-described embodiments, and the storage medium storing the program code constitutes another aspect of the present invention.

Further, the term “storage medium” includes not only paper used for an ordinary recording apparatus, but also a material that can accept ink. The material includes a cloth, a plastic film, a metal plate, glass, ceramic, wood, leather, etc.

Further, the term “ink” should be broadly interpreted as is the case with the term “storage medium”. That is, the term “ink” used in the above-described embodiments denotes a liquid applied onto the storage medium to form an image, a design, a pattern, etc., or process the storage medium. Further, the liquid can be used to process the ink (the solidification or the insolubilization of a color material included in the ink applied onto the recording medium).

Further, the term “nozzle” is a generic name for a discharge port, a liquid path communicated therewith, and an element generating energy used to discharge ink, except where specifically noted.

Further, although a system arranged to discharge ink with an electric thermal conversion element is illustrated in the above-described embodiments of the present invention, a system arranged to discharge ink with an electromechanical transducer such as a piezoelectric element may be adopted.

Further, in the above-described embodiments, the width of the recording medium is detected with an optical sensor and the detection data is input to a CPU which is a control unit. However, the width of the recording medium may be input to the CPU by a user in advance via an input unit.

In addition, an inkjet recording apparatus according to an embodiment of the present invention may be integrated into an information processing apparatus such as a computer as an image output terminal or separately provided. Further, the inkjet recording apparatus may be provided as a copier by combination with a reader or the like, and a facsimile device having the transmission-and-reception function.

Further, program code of software implementing the functional processing of the above-described embodiments is supplied to a system and/or an apparatus directly and/or remotely. Then, a computer of the system and/or the apparatus reads and executes the supplied program code, which constitutes another embodiment of the present invention. In that case, the program code itself installed in the computer, so as to achieve the functional processing of the present invention by the computer, also constitutes another embodiment of the present invention. Further, any program may be installed in the computer so long as the program can realize the functional processing of the present invention. Therefore, the program may take any form including object code, a program executed by an interpreter, script data supplied to an operating system (OS), etc.

Further, the program may be supplied in the following methods. For example, connection with the Internet may be established by using the browser of a client computer and the program itself of the present invention or compressed file data including data on an automatic-install function may be downloaded from a homepage. Further, the program can be supplied by dividing program code generating the program of the present invention into plural file-data items and downloading the file-data items from different home pages. Namely, a WWW server provided to download program-file-data items used to achieve the functional processing of the present invention by using a computer to plural users also constitutes another embodiment of the present invention.

Further, not only by the computer executing the read program, but also by the computer executing part of or the entire process utilizing an OS, etc. running on the computer based on instructions of the program, the functions of the above-described embodiments may be achieved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-283775 filed Dec. 20, 2010, which is hereby incorporated by reference herein in its entirety.

What is claimed is:

1. An inkjet recording apparatus recording an image onto a recording medium by causing a recording head including nozzle arrays of multiple colors, the nozzle arrays being arranged in a certain direction, to scan in a going direction and a returning direction of the certain direction, the inkjet recording apparatus comprising:
a record unit configured to finish recording with a first scan performed in the going direction, the first scan involving a discharge of ink to first and second regions of a recording medium, and a second scan performed in the returning direction, the second scan involving a discharge of ink to the first and second regions of a recording medium, and vary the number of scanning which does not involve a discharge of ink between the first and second regions, the scanning being performed between the first and second scans;
a generation unit configured to generate record data specifying a discharge of ink or a non-discharge of ink based on input image data for each pixel region of the first region and the second region; and
a determination unit configured to determine a ratio of recording performed in the going direction and a ratio of recording performed in the returning direction based on a value of the input image data in a plurality of the pixel regions,
wherein the generation unit generates the record data based on the going-direction recording ratio and the returning-direction recording ratio that are determined by the determination unit.

2. The inkjet recording apparatus according to claim 1, wherein the determination unit increases a difference between the going-direction recording ratio and the returning-direction recording ratio with an increase in the value of the input image data.

3. The inkjet recording apparatus according to claim 1, wherein the determination unit determines the going-direction recording ratio and the returning-direction recording ratio for each of the pixel regions, where a plurality of the pixel regions is determined to be a unit.

4. The inkjet recording apparatus according to claim 1, wherein the determination unit determines the going-direction recording ratio and the returning-direction recording ratio for each of the pixel regions based on the value of the input image data of the pixel regions and threshold-table data defined in relation to the pixel regions.

5. The inkjet recording apparatus according to claim 1, wherein the generation unit generates the record data based on a dot-arrangement pattern specifying whether a dot which is to be recorded onto the pixel region is recorded in the going direction or the returning direction.

6. The inkjet recording apparatus according to claim 1, wherein the determination unit determines the going-direction recording ratio and the returning-direction recording ratio based on a value obtained by weighting the value of the input image data with a coefficient determined for an ink color.

7. The inkjet recording apparatus according to claim 1, wherein the determination unit determines the going-direction recording ratio and the returning-direction recording ratio for each of the pixel regions based on a position of the pixel region in the certain direction.

8. The inkjet recording apparatus according to claim 1, wherein the determination unit determines the going-direction recording ratio and the returning-direction recording ratio for each of the pixel regions based on a hue of the pixel region.

9. The inkjet recording apparatus according to claim 1, wherein the record unit includes a conveying unit configured to convey the recording medium in a direction intersecting the certain direction, and the record unit conveys the recording medium in a forward direction of the intersecting direction and conveys the recording medium in a backward direction with the conveying unit so that data recording is performed for the first and second regions.

10. An inkjet recording method provided to record an image onto a recording medium by causing a recording head including nozzle arrays of multiple colors, the nozzle arrays being arranged in a certain direction, to scan in a going direction and a returning direction of the certain direction, the inkjet recording method comprising:
a recording step provided to finish recording with a first scan performed in the going direction, the first scan involving a discharge of ink to first and second regions of a recording medium, and a second scan performed in the returning direction, the second scan involving a discharge of ink to the first and second regions of a recording medium, and vary the number of scanning which does not involve a discharge of ink between the first and second regions, the scanning being performed between the first and second scans;
a generation step provided to generate record data specifying a discharge of ink or a non-discharge of ink based on input image data for each pixel region of the first region and the second region; and
a determination step provided to determine a ratio of recording performed in the going direction and a ratio of recording performed in the returning direction based on a value of the input image data in a plurality of the pixel regions,
wherein, at the generation step, the record data is generated based on the going-direction recording ratio and the returning-direction recording ratio that are determined at the determination step.

11. The inkjet recording method according to claim 10, wherein, at the determination step, a difference between the going-direction recording ratio and the returning-direction recording ratio is increased with an increase in the value of the input image data.

12. The inkjet recording method according to claim 10, wherein, at the determination step, the going-direction recording ratio and the returning-direction recording ratio are determined for each of the pixel regions, where a plurality of the pixel regions is determined to be a unit.

13. The inkjet recording method according to claim 10, wherein, at the determination step, the going-direction recording ratio and the returning-direction recording ratio are determined for each of the pixel regions based on the value of the input image data of the pixel regions and threshold-table data defined in relation to the pixel regions.
